(19) United States
(12) Patent Application Publication
(10) Pub. No.: US 2026/0303236 A1
(43) Pub. Date: Oct. 1, 2026

(54) METHOD AND DEVICE FOR MEASURING SIDELINK SIGNAL IN WIRELESS COMMUNICATION SYSTEM

(71) Applicant: Samsung Electronics Co., Ltd., Gyeonggi-do (KR)

(72) Inventors: Jeongseok YU, Gyeonggi-do (KR); Hyunjeong KANG, Gyeonggi-do (KR)

(21) Appl. No.: 19/480,252

(22) PCT Filed: May 14, 2024
(86) PCT No.: PCT/KR2024/006557

§ 371 Date: Oct. 30, 2025

(30) Foreign Application Priority Data
May 18, 2023 (KR) 10-2023-0064379
Jul. 12, 2023 (KR) 10-2023-0090386

(51) Int. Cl. H04B 17/318; H04W 24/10; H04W 40/22

(52) U.S. Cl. CPC H04B 17/328; H04W 24/10; H04W 40/22

(57) ABSTRACT

The present disclosure relates to a 5G or 6G communication system for supporting higher data transmission rates. The present disclosure provides a met hod performed by a terminal in a wireless communication system. The method may comprise the steps of: receiving, from a base station, configuration information including information associated with a condition for triggering a measurement report event; performing measurement associated with at least one L2 U2N relay terminal; checking whether the condition is satisfied on the basis of the configuration information and the measurement; and transmitting a report on a measurement result to the base station on the basis of satisfying the condition, wherein the information includes at least one of a first threshold value associated with SL-RSRP and a second threshold value associated with SD-RSRP, the first threshold value and the second threshold value are associated with measurement for a serving L2 U2N relay terminal, and the information further includes a third threshold value associated with measurement for a candidate L2 U2N relay terminal.

### TECHNICAL FIELD

The disclosure relates to a wireless communication system and, more particularly, to a method and apparatus for measuring a sidelink signal in a wireless communication system.

### BACKGROUND ART

Fifth generation (5G) mobile communication technology defines a wide frequency band to enable fast transmission speed and new services, and can be implemented not only in a sub-6 GHz frequency band (“sub 6 GHz”) such as 3.5 GHz but also in an ultra-high frequency band (“above 6 GHz”) called mmWave such as 28 GHz or 39 GHz. In addition, 6G mobile communication technology called “beyond 5G system” is being considered for implementation in a terahertz (THz) band (e.g., band of 95 GHz to 3 THz) to achieve transmission speed that is 50 times faster and ultra-low latency that is reduced to 1/10 compared with 5G mobile communication technology.

In the early days of 5G mobile communication technology, to meet service support and performance requirements for enhanced mobile broadband (eMBB), ultra-reliable and low-latency communication (URLLC), and massive machine-type communications (mMTC), standardization has been carried out regarding beamforming for mitigating the pathloss of radio waves and increasing the propagation distance thereof in the mmWave band, massive MIMO, support of various numerology for efficient use of ultra-high frequency resources (e.g., operating multiple subcarrier spacings), dynamic operations on slot formats, initial access schemes to support multi-beam transmission and broadband, definition and operation of bandwidth parts (BWP), new channel coding schemes such as low density parity check (LDPC) codes for large-capacity data transmission and polar codes for reliable transmission of control information, L2 pre-processing, and network slicing for providing a dedicated network specialized for a specific service.

Currently, discussions are underway to improve 5G mobile communication technology and enhance performance thereof in consideration of the services that the 5G mobile communication technology has initially intended to support, and physical layer standardization is in progress for technologies such as V2X (Vehicle-to-Everything) that aims to help a self-driving vehicle to make driving decisions based on its own location and status information transmitted by vehicles and to increase user convenience, new radio unlicensed (NR-U) for the purpose of system operation that meets various regulatory requirements in unlicensed bands, low power consumption scheme for NR terminals (UE power saving), non-terrestrial network (NTN) as direct terminal-satellite communication to secure coverage in an area where communication with a terrestrial network is not possible, and positioning.

In addition, standardization in radio interface architecture/protocol is in progress for technologies such as intelligent factories (industrial Internet of things, IIoT) for new service support through linkage and convergence with other industries, integrated access and backhaul (IAB) that provides nodes for network service area extension by integrating and supporting wireless backhaul links and access links, mobility enhancement including conditional handover and dual active protocol stack (DAPS) handover, 2-step random access (2-step RACH for NR) that simplifies the random access procedure; and standardization in system architecture/service is also in progress for the 5G baseline architecture (e.g., service based architecture, service based interface) for integrating network functions virtualization (NFV) and software defined networking (SDN) technologies, and mobile edge computing (MEC) where the terminal receives a service based on its position.

When such a 5G mobile communication system is commercialized, connected devices whose number is explosively increasing will be connected to the communication networks; accordingly, it is expected that enhancement in function and performance of the 5G mobile communication system and the integrated operation of the connected devices will be required. To this end, new research will be conducted regarding 5G performance improvement and complexity reduction, AI service support, metaverse service support, and drone communication by utilizing extended reality (XR) for efficiently supporting augmented reality (AR), virtual reality (VR), and mixed reality (MR), artificial intelligence (AI), and machine learning (ML).

Further, such advancement of 5G mobile communication systems will be the basis for the development of technologies such as new waveforms for ensuring coverage in the terahertz band of 6G mobile communication technology, full dimensional MIMO (FD-MIMO), multi-antenna transmission such as array antenna or large scale antenna, metamaterial-based lenses and antennas for improved coverage of terahertz band signals, high-dimensional spatial multiplexing using orbital angular momentum (OAM), reconfigurable intelligent surface (RIS) technique, full duplex technique to improve frequency efficiency and system network of 6G mobile communication technology, satellites, AI-based communication that utilizes artificial intelligence (AI) from the design stage and internalizes end-to-end AI support functions to realize system optimization, and next-generation distributed computing that realizes services whose complexity exceeds the limit of terminal computing capabilities by utilizing ultra-high-performance communication and computing resources.

### DISCLOSURE

### Technical Problem

The disclosure provides a method and device for measuring a sidelink signal in a wireless communication system so as to provide more efficient selection or reselection of a sidelink relay UE and reporting of measurement results on a candidate sidelink relay UE.

The technical objectives to be achieved in the disclosure are not limited to those mentioned above, and other technical objectives not mentioned can be clearly understood by a person having ordinary skill in the art to which the disclosure belongs from the description below.

### Technical Solution

A method performed by a user equipment (UE) in a wireless communication system according to an aspect of the disclosure may include: receiving, from a base station, configuration information including information associated with a condition for triggering a measurement report event; performing measurement associated with at least one layer 2 (L2) UE-to-network (U2N) relay UE; determining whether the condition is satisfied based on the configuration information and the measurement; and transmitting a report on the measurement result to the base station based on satisfaction of the condition, wherein the information may include at least one of a first threshold associated with sidelink reference signal received power (SL-RSRP) or a second threshold associated with sidelink discovery reference signal received power (SD-RSRP), and the first threshold and the second threshold may be associated with measurement for a serving L2 U2N relay UE, and wherein the information may further include a third threshold associated with measurement for a candidate L2 U2N relay UE.

A method performed by a base station in a wireless communication system according to another aspect of the disclosure may include: transmitting, to a user equipment (UE), configuration information including information associated with a condition for triggering a measurement report event; and receiving a report on a measurement result from the UE based on satisfaction of the condition, wherein whether the condition is satisfied may be determined based on the configuration information and measurement associated with at least one layer 2 (L2) UE-to-network (U2N) relay UE, wherein the information may include at least one of a first threshold associated with sidelink reference signal received power (SL-RSRP) or a second threshold associated with sidelink discovery reference signal received power (SD-RSRP), and the first threshold and the second threshold may be associated with measurement for a serving L2 U2N relay UE, and wherein the information may further include a third threshold associated with measurement for a candidate L2 U2N relay UE.

A user equipment (UE) in a wireless communication system according to another aspect of the disclosure may include: a transceiver; and at least one processor, wherein the at least one processor may be configured to: receive, from a base station, configuration information including information associated with a condition for triggering a measurement report event; perform measurement associated with at least one layer 2 (L2) UE-to-network (U2N) relay UE; determine whether the condition is satisfied based on the configuration information and the measurement; and transmit a report on the measurement result to the base station based on satisfaction of the condition, wherein the information may include at least one of a first threshold associated with sidelink reference signal received power (SL-RSRP) or a second threshold associated with sidelink discovery reference signal received power (SD-RSRP), and the first threshold and the second threshold may be associated with measurement for a serving L2 U2N relay UE, and wherein the information may further include a third threshold associated with measurement for a candidate L2 U2N relay UE.

A base station in a wireless communication system according to another aspect of the disclosure may include: a transceiver; and at least one processor, wherein the at least one processor may be configured to: transmit, to a user equipment (UE), configuration information including information associated with a condition for triggering a measurement report event; and receive a report on a measurement result from the UE based on satisfaction of the condition, wherein whether the condition is satisfied may be determined based on the configuration information and measurement associated with at least one layer 2 (L2) UE-to-network (U2N) relay UE, wherein the information may include at least one of a first threshold associated with sidelink reference signal received power (SL-RSRP) or a second threshold associated with sidelink discovery reference signal received power (SD-RSRP), and the first threshold and the second threshold may be associated with measurement for a serving L2 U2N relay UE, and wherein the information may further include a third threshold associated with measurement for a candidate L2 U2N relay UE.

### Advantageous Effects

According to embodiments of the disclosure, a UE wishing to perform sidelink relaying can utilize a signal measurement method configured by the network to measure the signal of a currently connected sidelink relay UE or a candidate sidelink relay UE. The signal measurement results of the sidelink relay UE measured using the signal measurement method configured by the network may be used as a criterion for selection or reselection of a sidelink relay UE, or may be reported to the base station so that pass switching can be initiated.

The effects that can be obtained from the disclosure are not limited to those mentioned above, and other effects that are not mentioned can be clearly understood by a person having ordinary skill in the art to which the disclosure belongs from the description below.

### DESCRIPTION OF DRAWINGS

FIG. 1 is a diagram illustrating the architecture of a wireless communication system according to an embodiment of the disclosure.

FIG. 2 is a diagram illustrating the structure of user plane radio protocols in the wireless communication system according to an embodiment of the disclosure.

FIG. 3 is a diagram illustrating the structure of control plane radio protocols in the wireless communication system according to an embodiment of the disclosure.

FIG. 4A is a diagram illustrating an example of scenarios for sidelink communication in a wireless communication system according to an embodiment of the disclosure.

FIG. 4B is a diagram illustrating an example of scenarios for sidelink communication in a wireless communication system according to an embodiment of the disclosure.

FIG. 4C is a diagram illustrating an example of scenarios for sidelink communication in a wireless communication system according to an embodiment of the disclosure.

FIG. 4D is a diagram illustrating an example of scenarios for sidelink communication in a wireless communication system according to an embodiment of the disclosure.

FIG. 5 is a diagram illustrating the structure of radio protocols for sidelink U2N (UE-to-network) relaying in a wireless mobile communication system according to an embodiment of the disclosure.

FIG. 6 is a diagram illustrating an example of scenarios for sidelink U2N relay communication in a wireless communication system according to an embodiment of the disclosure.

FIG. 7 is a diagram illustrating signal flows in which threshold values are set for a U2N relay UE and a U2N remote UE, and the U2N remote UE selects or reselects a U2N relay UE in a wireless communication system according to an embodiment of the disclosure.

FIG. 8 is a diagram illustrating signal flows in which a U2N remote UE selects or reselects a U2N relay UE and connects to the network in a wireless communication system according to an embodiment of the disclosure.

FIG. 9 is a diagram illustrating signal flows in which the base station configures signal measurements and measurement reporting to a U2N remote UE in a wireless communication system according to an embodiment of the disclosure.

FIG. 10 is a diagram illustrating signal flows in which a U2N remote UE measures signals of a U2N relay UE and a candidate U2N relay UE and reports the measurement results to the base station in a wireless communication system according to an embodiment of the disclosure.

FIG. 11 is a diagram illustrating signal flows in which the base station performs pass switching based on signals of a U2N relay UE and a candidate U2N relay UE reported by a U2N remote UE in a wireless communication system according to an embodiment of the disclosure.

FIG. 12 is a diagram illustrating the structure of a base station in a wireless communication system according to an embodiment of the disclosure.

FIG. 13 is a diagram illustrating the structure of a UE in a wireless communication system according to an embodiment of the disclosure.

FIG. 14 is a diagram illustrating UE operation for handling sidelink discovery message monitoring according to an embodiment of the present disclosure.

FIG. 15 illustrates UE operation for handling sidelink discovery message transmission according to an embodiment of the disclosure.

### MODE FOR DISCLOSURE

Hereinafter, embodiments of the disclosure will be described in detail with reference to the accompanying drawings.

In the following description of embodiments, descriptions of technical details well known in the art and not directly related to the disclosure may be omitted. This is to more clearly convey the subject matter of the disclosure without obscurities by omitting unnecessary descriptions.

Likewise, in the drawings, some elements are exaggerated, omitted, or only outlined in brief. Also, the size of each element does not necessarily reflect the actual size. The same or similar reference symbols are used throughout the drawings to refer to the same or like parts.

Advantages and features of the disclosure and methods for achieving them will be apparent from the following detailed description of embodiments taken in conjunction with the accompanying drawings. However, the disclosure is not limited to the embodiments disclosed below but may be implemented in various different ways, the embodiments are provided only to complete the disclosure and to fully inform the scope of the disclosure to those skilled in the art to which the disclosure pertains, and the disclosure is defined only by the scope of the claims. The same reference symbols are used throughout the description to refer to the same parts. In addition, when describing the disclosure, detailed descriptions of related functions or configurations will be omitted if they are deemed to unnecessarily obscure the subject matter of the disclosure. Further, those terms described below are defined based on their functions in the disclosure, and may vary depending on the intention or custom of the user or operator. Hence, their meanings should be determined based on the overall contents of this specification.

In describing the embodiments of the disclosure, the main target is New Radio (NR), which is a wireless access network, and the core network, packet core 5G System, or 5G core network, or NG core (next generation core), in the 5G mobile communication standards specified by 3GPP (3rd Generation Partnership Project) being a mobile communication standardization organization. However, the main gist of the disclosure may be applied to other communication systems having similar technical backgrounds with minor modifications not significantly departing from the scope of the disclosure. This will be possible at the discretion of a person having technical knowledge and skilled in the technical field of the disclosure.

For the convenience of description below, some terms and names defined in the 3GPP standards (standards for 5G, NR, LTE, or similar systems) may be used. However, the disclosure is not limited by such terms and names and may be equally applied to systems conforming to other standards.

Those terms used in the following description for identifying an access node, indicating a network entity, indicating a message, indicating an interface between network entities, and indicating various identification information are taken as illustration for ease of description. Accordingly, the disclosure is not limited by the terms to be described later, and other terms referring to objects having an equivalent technical meaning may be used.

In the following description, the “base station (BS)”, as a main agent that allocates resources to a terminal, may be at least one of Node B, eNode B, gNode B, radio access unit, base station controller, or node on a network. The “terminal” may include a user equipment (UE), a mobile station (MS), a cellular phone, a smartphone, a computer, or a multimedia system capable of performing a communication function. In the disclosure, downlink (DL) refers to a wireless transmission path through which a base station transmits a signal to a terminal, and uplink (UL) refers to a wireless transmission path through which a terminal transmits a signal to a base station.

Meanwhile, it is known to those skilled in the art that blocks of a flowchart (or sequence diagram) and a combination of flowcharts may be executed by computer program instructions. These computer program instructions may be loaded on a processor of a general purpose computer, special purpose computer or programmable data processing equipment. When the loaded program instructions are executed by the processor, they create a means for carrying out functions described in the flowchart. As the computer program instructions may be stored in a computer readable memory that is usable in a specialized computer or a programmable data processing equipment, it is also possible to create articles of manufacture that carry out functions described in the flowchart. As the computer program instructions may be loaded on a computer or a programmable data processing equipment, when executed as processes, they may carry out steps of functions described in the flowchart.

In addition, a block of a flowchart may correspond to a module, a segment or a code containing one or more executable instructions implementing one or more logical functions, or to a part thereof. In some cases, functions described by blocks may be executed in an order different from the listed order. For example, two blocks listed in sequence may be executed at the same time or executed in reverse order according to their corresponding functions.

In the description, the word “unit”, “module” or the like may refer to a software component or hardware component such as an FPGA (field programmable gate array) or ASIC (application specific integrated circuit) capable of carrying out a function or an operation. However, “unit” or the like is not limited to hardware or software. A unit or the like may be configured so as to reside in an addressable storage medium or to drive one or more processors. Units or the like may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose large components and units. Components and units may be configured to drive a device or one or more processors in a secure multimedia card. Also, in an embodiment, a unit or the like may include one or more processors.

Fifth generation (5G) mobile communication technology defines a wide frequency band to enable fast transmission speed and new services, and can be implemented not only in a sub-6 GHz frequency band (“sub 6 GHz”) such as 3.5 GHz but also in an ultra-high frequency band (“above 6 GHz”) called mmWave such as 28 GHz or 39 GHz. In addition, 6G mobile communication technology called “beyond 5G system” is being considered for implementation in a terahertz (THz) band (e.g., band of 95 GHz to 3 THz) to achieve transmission speed that is 50 times faster and ultra-low latency that is reduced to 1/10 compared with 5G mobile communication technology.

In the early days of 5G mobile communication technology, to meet service support and performance requirements for enhanced mobile broadband (eMBB), ultra-reliable and low-latency communication (URLLC), and massive machine-type communications (mMTC), standardization has been carried out regarding beamforming for mitigating the pathloss of radio waves and increasing the propagation distance thereof in the mm Wave band, massive MIMO, support of various numerology for efficient use of ultra-high frequency resources (e.g., operating multiple subcarrier spacings), dynamic operations on slot formats, initial access schemes to support multi-beam transmission and broadband, definition and operation of bandwidth parts (BWP), new channel coding schemes such as low density parity check (LDPC) codes for large-capacity data transmission and polar codes for reliable transmission of control information, L2 pre-processing, and network slicing for providing a dedicated network specialized for a specific service.

Currently, discussions are underway to improve 5G mobile communication technology and enhance performance thereof in consideration of the services that the 5G mobile communication technology has initially intended to support, and physical layer standardization is in progress for technologies such as V2X (Vehicle-to-Everything) that aims to help a self-driving vehicle to make driving decisions based on its own location and status information transmitted by vehicles and to increase user convenience, new radio unlicensed (NR-U) for the purpose of system operation that meets various regulatory requirements in unlicensed bands, low power consumption scheme for NR terminals (UE power saving), non-terrestrial network (NTN) as direct terminal-satellite communication to secure coverage in an area where communication with a terrestrial network is not possible, and positioning.

In addition, standardization in radio interface architecture/protocol is in progress for technologies such as intelligent factories (industrial Internet of things, IIoT) for new service support through linkage and convergence with other industries, integrated access and backhaul (IAB) that provides nodes for network service area extension by integrating and supporting wireless backhaul links and access links, mobility enhancement including conditional handover and dual active protocol stack (DAPS) handover, 2-step random access (2-step RACH for NR) that simplifies the random access procedure; and standardization in system architecture/service is also in progress for the 5G baseline architecture (e.g., service based architecture, service based interface) for integrating network functions virtualization (NFV) and software defined networking (SDN) technologies, and mobile edge computing (MEC) where the terminal receives a service based on its position.

When such a 5G mobile communication system is commercialized, connected devices whose number is explosively increasing will be connected to the communication networks; accordingly, it is expected that enhancement in function and performance of the 5G mobile communication system and the integrated operation of the connected devices will be required. To this end, new research will be conducted regarding 5G performance improvement and complexity reduction, AI service support, metaverse service support, and drone communication by utilizing extended reality (XR) for efficiently supporting augmented reality (AR), virtual reality (VR), and mixed reality (MR), artificial intelligence (AI), and machine learning (ML).

Further, such advancement of 5G mobile communication systems will be the basis for the development of technologies such as new waveforms for ensuring coverage in the terahertz band of 6G mobile communication technology, full dimensional MIMO (FD-MIMO), multi-antenna transmission such as array antenna or large scale antenna, metamaterial-based lenses and antennas for improved coverage of terahertz band signals, high-dimensional spatial multiplexing using orbital angular momentum (OAM), reconfigurable intelligent surface (RIS) technique, full duplex technique to improve frequency efficiency and system network of 6G mobile communication technology, satellites, AI-based communication that utilizes artificial intelligence (AI) from the design stage and internalizes end-to-end AI support functions to realize system optimization, and next-generation distributed computing that realizes services whose complexity exceeds the limit of terminal computing capabilities by utilizing ultra-high-performance communication and computing resources.

The disclosure relates to a method and device for setting priorities for sidelink (SL) positioning reference signals in a wireless communication system. More specifically, the disclosure relates to a method and apparatus in a 3GPP 5G system for setting priorities included in sidelink positioning reference signals (SL-PRS) and sidelink control information (SCI) indicating resources of the SL-PRS, which can be transmitted by at least two UEs that may be within and/or outside the base station communication range to perform sidelink positioning (SL-POS).

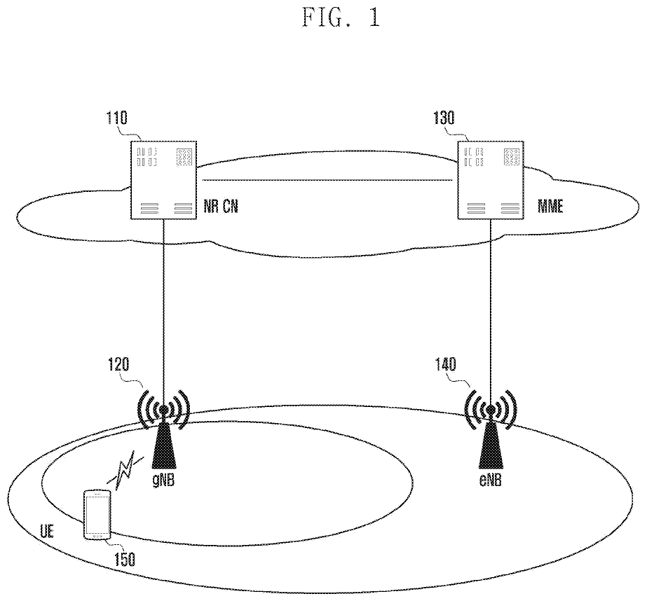

FIG. 1 is a diagram illustrating the architecture of a wireless communication system according to an embodiment of the disclosure.

With reference to FIG. 1, the wireless access network of a wireless communication system (referred to as NR or 5G) may be configured to include a next-generation base station (new radio node B, NR gNB, gNB, or base station) 120 and a new radio core network (NR CN) 110. A user equipment (new radio user equipment, NR UE, or UE) 150 may connect to an external network through the NR gNB 120 and NR CN 110.

In FIG. 1, the NR gNB 120 may correspond to the eNB 140 of the LTE system. The NR gNB 120 may be connected to the NR UE 150 through a radio channel, and may provide a more superior service than that of the eNB 140. All user traffic may be serviced through shared channels in the next-generation mobile communication system. Hence, there is a need for an entity that performs scheduling by collecting status information, such as buffer states, available transmission power states, and channel states of individual UEs, and the NR gNB 120 may take charge of this scheduling. One NR gNB 120 may normally control a plurality of cells. To implement ultra-high-speed data transmission compared with LTE, a bandwidth beyond the maximum bandwidth of LTE may be utilized, and a beamforming technology may be additionally combined with orthogonal frequency division multiplexing (OFDM) serving as a radio access technology. Further, an adaptive modulation and coding (AMC) scheme determining a modulation scheme and channel coding rate to match the channel state of the UE may be applied. The NR CN 110 may perform functions such as mobility support and quality-of-service (QoS) configuration. The NR CN 110 is an entity taking charge of not only mobility management but also various control functions for the UE, and may be connected to a plurality of base stations. In addition, the next-generation mobile communication system may interwork with the LTE system, and the NR CN 110 may be connected to a mobility management entity (MME) 130 through a network interface. The MME 130 may be connected to the eNB 140.

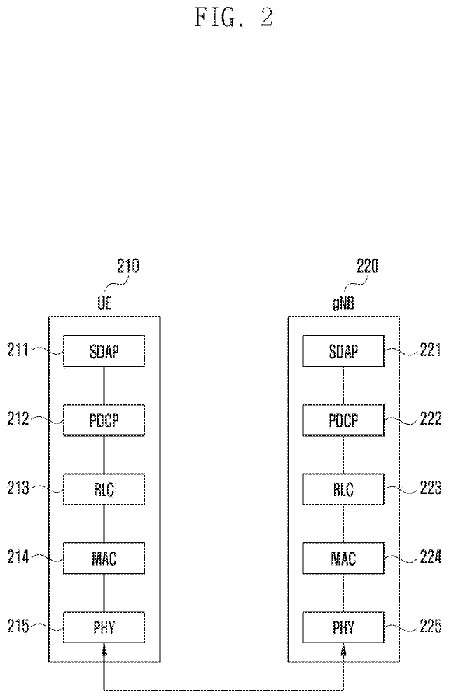

FIG. 2 is a diagram illustrating the structure of user plane radio protocols in a wireless communication system according to an embodiment of the disclosure.

With reference to FIG. 2, the user plane radio protocols of a wireless communication system may be composed of, in the UE 210, service data adaptation protocol (SDAP) 211, packet data convergence protocol (PDCP) 212, radio link control (RLC) 213, medium access control (MAC) 214, and/or physical layer (PHY) 215. In the gNB 220, they may be composed of SDAP 221, PDCP 222, RLC 223, MAC 224, and/or PHY 225. In this disclosure, the term “may be composed of” can be replaced with the term “may include”. For example, the user plane radio protocols of a wireless communication system may include, in the UE 210, SDAP 211, PDCP 212, RLC 213, MAC 214, and/or PHY 215.

The functionality of the SDAP 211 or 221 may include at least some of the following functions.
Mapping between QoS flows and data radio bearers (mapping between a QoS flow and a data radio bearer)
QoS flow ID (QFI) marking in uplink and downlink packets (marking QoS flow ID in both DL packets and UL packets)

The main functionality of the PDCP 212 or 222 may include some of the following functions.
Transfer of data (user plane or control plane)
Maintaining PDCP sequence numbers (maintenance of PDCP SNs)
Header compression and decompression using ROHC protocol
Header compression and decompression using EHC protocol
Compression and decompression of uplink PDCP SDUs (service data units) (DEFLATE based UDC only)
Ciphering and deciphering
Integrity protection and integrity verification
Timer based SDU discard
Routing for split bearers
Duplication
Reordering and in-order delivery
Out-of-order delivery
Duplicate discarding

The main functionality of the RLC 213 or 223 may include some of the following functions.
Transfer of upper layer PDUs
Sequence numbering independent of the one in PDCP (UM and AM)
Error correction through ARQ (AM only)
Segmentation (AM and UM) and re-segmentation (AM only) of RLC SDUs
Reassembly of SDU (AM and UM)
Duplicate detection (AM only)
RLC SDU discard (AM and UM)
RLC re-establishment
Protocol error detection (AM only)

The main functionality of the MAC 214 or 224 may include at least some of the following functions.
Mapping between logical channels and transport channels
Multiplexing of MAC SDUs coming from one or more logical channels (multiplexing of MAC SDUs from one or different logical channels onto transport blocks (TB) to be delivered to the physical layer on transport channels)
Demultiplexing of MAC SDUs to one or more logical channels (demultiplexing of MAC SDUs to one or different logical channels from transport blocks (TB) delivered from the physical layer on transport channels)
Scheduling information reporting
Error correction through HARQ
Logical channel prioritization
Priority handling between overlapping resources of one UE

The PHY layer 215 or 225 may compose OFDM symbols from higher layer data through coding and modulation and transmit them through an antenna. Also, the PHY layer 215 or 225 may demodulate and decode received OFDM symbols and forward the result to a higher layer.

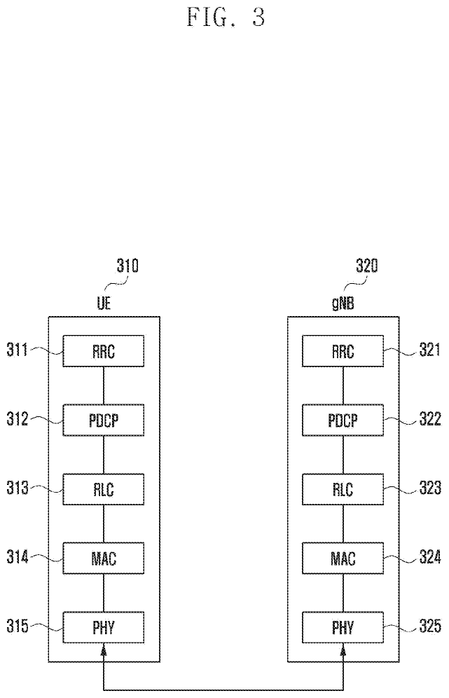

FIG. 3 is a diagram illustrating the structure of control plane radio protocols in a wireless communication system according to an embodiment of the disclosure.

With reference to FIG. 3, the control plane radio protocols of a wireless communication system may be composed of, in the UE 310, RRC (radio resource control) 311, PDCP 312, RLC 313, MAC 314, and/or PHY 315. In the gNB 320, they may be composed of RRC 321, PDCP 322, RLC 323, MAC 324, and/or PHY 325.

The functionality of the RRC 311 or 321 may include at least some of the following functions.
Broadcasting of system information related to AS and NAS
Paging initiated by 5GC or NG-RAN
Establishment, maintenance and release of an RRC connection between the UE and NG-RAN including: addition, modification and release of carrier aggregation; addition, modification and release of dual connectivity between NR and NR or between E-UTRA (LTE) and NR.
Security functions including key management
Establishment, configuration, maintenance and release of signaling radio bearers (SRBs) and data radio bearers (DRBs)
UE mobility support (mobility functions including: handover and context transfer; UE cell selection and reselection, and control of cell selection and reselection; inter-RAT mobility)
QoS management functions
UE measurement reporting and reporting control
Detection of and recovery from radio link failure
NAS message transfer to/from NAS from/to UE

The main functions of PDCP 312 or 322, RLC 313 or 323, MAC 314 or 324, and/or PHY 315 or 325 may follow the corresponding examples described in FIG. 2.

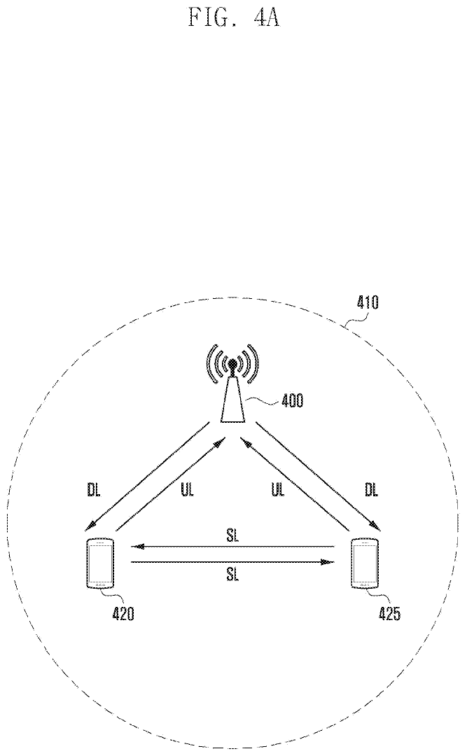

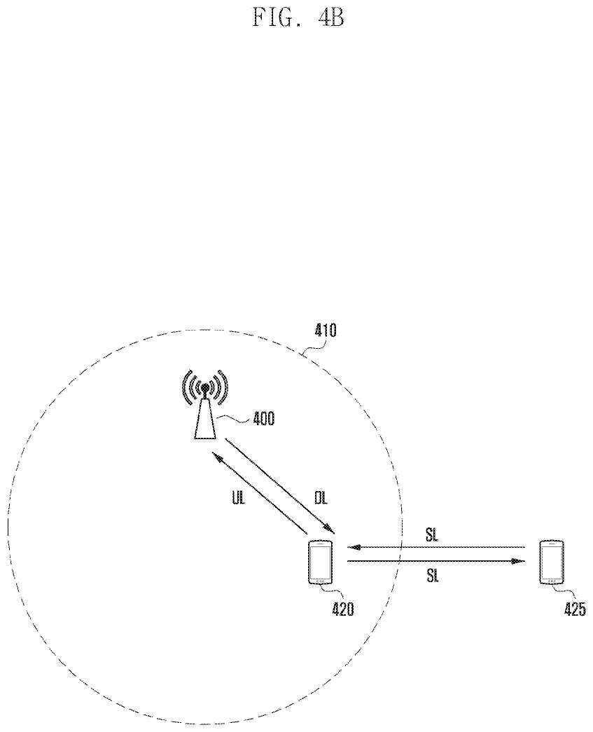

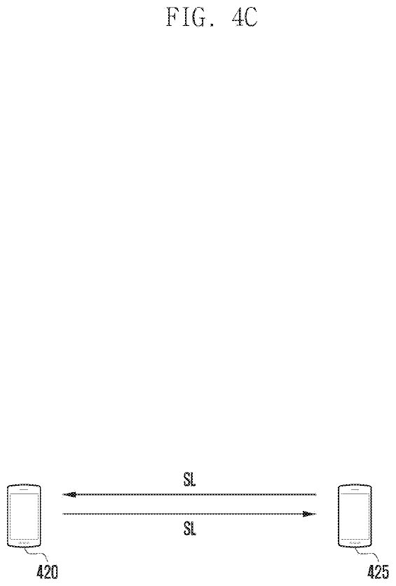

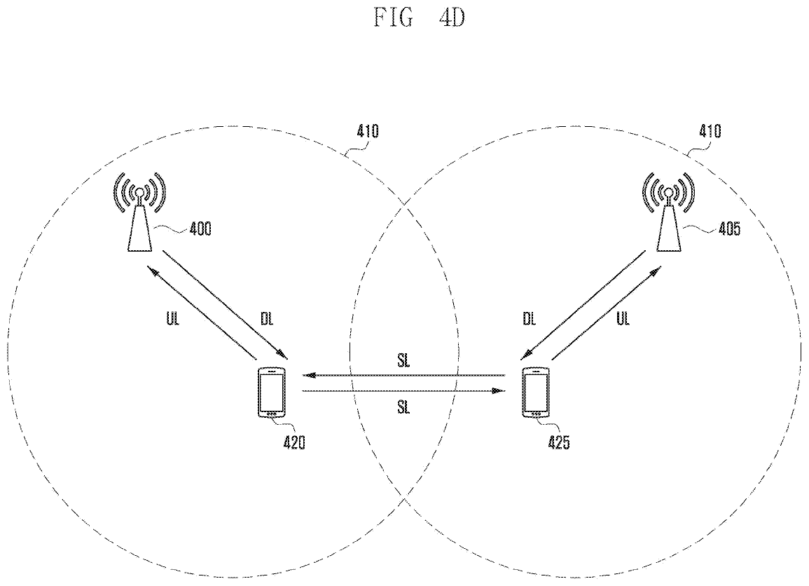

FIG. 4A is a diagram illustrating an example of scenarios for sidelink communication in a wireless communication system according to an embodiment of the disclosure.

Specifically, FIG. 4A illustrates an in-coverage (IC) scenario in which sidelink UEs 420 and 425 are located within the coverage 410 of the base station 400.

With reference to FIG. 4A, the sidelink UEs 420 and 425 may receive data and control information through a downlink (DL) from the base station 400, or may transmit data and control information to the base station 400 through an uplink (UL). In this case, the data and control information may be data and control information for sidelink communication or data and control information for regular cellular communication other than sidelink communication. Also, the sidelink UEs 420 and 425 may transmit and receive data and control information for sidelink communication through a sidelink.

FIG. 4B is a diagram illustrating an example of scenarios for sidelink communication in a wireless communication system according to an embodiment of the disclosure.

Specifically, FIG. 4B illustrates a partial coverage (PC) case in which a first UE 420 among sidelink UEs is located within the coverage 410 of the base station 400 and a second UE 425 is located outside the coverage 410 of the base station 400.

With reference to FIG. 4B, the first UE 420 located within the coverage 410 of the base station 400 may receive data and control information from the base station 400 through the downlink, or may transmit data and control information to the base station 400 through the uplink. The second UE 425 located outside the coverage of the base station 400 cannot directly receive data and control information from the base station 400 through the downlink, and cannot directly transmit data and control information to the base station 400 through the uplink. The second UE 425 may transmit or receive data and control information for sidelink communication to or from the first UE 420 through the sidelink.

FIG. 4C is a diagram illustrating an example of scenarios for sidelink communication in a wireless communication system according to an embodiment of the disclosure.

Specifically, FIG. 4C illustrates an out-of-coverage (OOC) case in which sidelink UEs (e.g., first UE 420 and second UE 425) are located outside the coverage of the base station.

With reference to FIG. 4C, neither the first UE 420 nor the second UE 425 can receive data and control information from the base station through the downlink, and can transmit data and control information to the base station through the uplink. The first UE 420 and the second UE 425 may transmit or receive data and control information for sidelink communication through the sidelink.

FIG. 4D is a diagram illustrating an example of scenarios for sidelink communication in a wireless communication system according to an embodiment of the disclosure.

Specifically, FIG. 4D illustrates a case where a first UE 420 and a second UE 425 in sidelink communication perform inter-cell sidelink communication in a situation where they are connected to different base stations (e.g., first base station 400 and second base station 405) (e.g., RRC connected state) or are camping thereon (e.g., RRC disconnected state, i.e., RRC idle or inactive state).

With reference to FIG. 4D, the first UE 420 may be a sidelink transmitting UE, and the second UE 425 may be a sidelink receiving UE. Alternatively, the first UE 420 may be a sidelink receiving UE, and the second UE 425 may be a sidelink transmitting UE. The first UE 420 may receive a sidelink dedicated system information block (SIB) from the base station 400 to which it is connected (or, on which it is camping), and the second UE 425 may receive a sidelink dedicated SIB from another base station 405 to which it is connected (or, on which it is camping). In this case, the information of the sidelink dedicated SIB received by the first UE 420 and the information of the sidelink dedicated SIB received by the second UE 425 may be different from each other. Hence, it may be necessary to unify information for sidelink communication between UEs located in different cells or provide additional assumptions and interpretation schemes for such information.

In the examples of FIGS. 4A to 4D, a sidelink system composed of two UEs (e.g., first UE 420 and second UE 425) has been described for convenience of explanation, but the disclosure is not limited thereto and may also be applied to a sidelink system composed of three or more UEs. In addition, the uplink and downlink between the base station 400 and the sidelink UEs may be referred to as a Uu interface, and the sidelink between sidelink UEs may be referred to as a PC5 interface. Further, a sidelink UE situated in OOC where a Uu interface to the base station 400 is not established may indirectly receive data and control information from the base station through relaying of another sidelink UE situated in IC where the Uu interface to the base station is established. In the following description, uplink or downlink and Uu interface may be used interchangeably, and sidelink and PC5 may be used interchangeably.

Meanwhile, in the disclosure, the UE may refer to a vehicle supporting vehicle-to-vehicle (V2V) communication, a vehicle or pedestrian handset (i.e., smartphone) supporting vehicle-to-pedestrian (V2P) communication, a vehicle supporting vehicle-to-network (V2N) communication, or a vehicle supporting vehicle-to-infrastructure (V2I) communication. Further, in the disclosure, the UE may refer to a road side unit (RSU) equipped with UE functionality, an RSU equipped with base station functionality, or an RSU equipped with some of base station functionality and some of UE functionality. In addition, the UE may refer to a UE that supports proximity services (ProSe) and SL-POS.

Additionally, in the disclosure, the base station may be a base station that supports both sidelink communication and regular cellular communication, or a base station that supports only sidelink. Here, the base station may be a 5G base station (gNB), a 4G base station (eNB), or an RSU. So, in this disclosure, the base station may be referred to as an RSU.

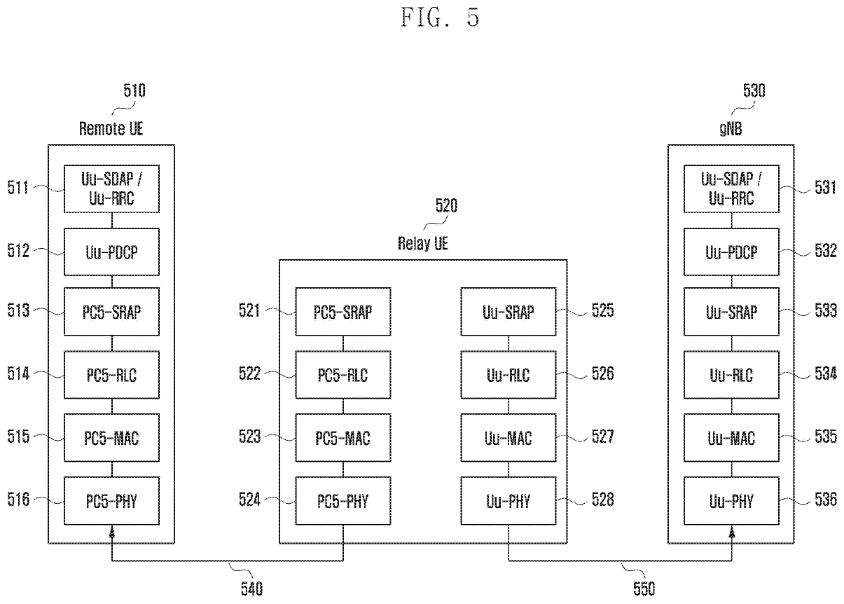

FIG. 5 is a diagram illustrating the structure of radio protocols for sidelink U2N (UE-to-network) relaying in a wireless mobile communication system according to an embodiment of the disclosure.

Referring to FIG. 5, the wireless protocols of U2N (UE to network) relaying may be composed of, in a remote UE 510, Uu-SDAP or Uu-RRC 511, Uu-PDCP 512, PC5-SRAP (sidelink relay adaptation protocol) 513, PC5-RLC 514, PC5-MAC 515, and/or PC5-PHY 516, may be composed of, in a relay UE 520, PC5-SRAP 521, PC5-RLC 522, PC5-MAC 523, PC5-PHY 524, Uu-SRAP 525, Uu-RLC 526, Uu-MAC 527, and/or Uu-PHY 528, and may be composed of, in a gNB 530, Uu-SDAP or Uu-RRC 531, Uu-PDCP 532, Uu-SRAP 533, Uu-RLC 534, Uu-MAC 535, and/or Uu-PHY 536. In this disclosure, the term “may be composed of” can be replaced with the term “may include”. For example, the wireless protocols of U2N relaying may include, in the remote UE 510, Uu-SDAP or Uu-RRC 511, Uu-PDCP 512, PC5-SRAP 513, PC5-RLC 514, PC5-MAC 515, and/or PC5-PHY 516.

The functionality of the Uu-SDAP 511 or 531 may include at least some of the following functions.
Mapping between QoS flows and data radio bearers (mapping between a QoS flow and a data radio bearer)
QoS flow ID (QFI) marking in uplink and downlink packets (marking QoS flow ID in both DL packets and UL packets)

The functionality of the Uu-RRC 511 or 531 may include at least some of the following functions.
System information broadcasting (broadcasting of system information related to AS and NAS)
Paging (paging initiated by 5GC or NG-RAN)
Establishment, maintenance and release of an RRC connection between the UE and NG-RAN including: addition, modification and release of carrier aggregation; addition, modification and release of dual connectivity between NR and NR or between E-UTRA (LTE) and NR
Security functions including key management
Establishment, configuration, maintenance and release of signaling radio bearers (SRBs) and data radio bearers (DRBs)
UE mobility support (mobility functions including: handover and context transfer; UE cell selection and reselection, and control of cell selection and reselection; inter-RAT mobility)
QoS management functions
UE measurement reporting and reporting control
Detection of and recovery from radio link failure
NAS message transfer to/from NAS from/to UE

Additionally, some of the following functions may be included to support the sidelink functionality.
Configuring sidelink resource allocation via system information or dedicated signaling
Reporting of UE sidelink information
Measurement configuration and reporting related to sidelink
Reporting of UE assistance information for SL traffic pattern(s)

The main functionality of the Uu-PDCP 512 or 532 may include some of the following functions.
Transfer of data (user plane or control plane)
Maintaining PDCP sequence numbers (maintenance of PDCP SNs)
Header compression and decompression using ROHC protocol
Header compression and decompression using EHC protocol
Compression and decompression of uplink PDCP SDUs (DEFLATE based UDC only)
Ciphering and deciphering
Integrity protection and integrity verification
Timer based SDU discard
Routing for split bearers
Duplication
Reordering and in-order delivery
Out-of-order delivery
Duplicate discarding

The functionality of the PC5 or Uu SRAP 513, 521, 525 or 533 may include at least some of the following functions.
Data transfer
Determination of UE ID field and BEARER ID field for data packets
Determination of egress link
Determination of egress RLC channel

The main functionality of the PC5 or Uu RLC 514, 522, 526 or 534 may include some of the following functions.
Transfer of upper layer PDUs
Sequence numbering independent of the one in PDCP (UM and AM)
Error correction through ARQ (AM only)
Segmentation (AM and UM) and re-segmentation (AM only) of RLC SDUs
Reassembly of SDU (AM and UM)
Duplicate detection (AM only)
RLC SDU discard (AM and UM)
RLC re-establishment
Protocol error detection (AM only)

The main functionality of the PC5 or Uu MAC 515, 523, 527 or 535 may include at least some of the following functions.
Mapping between logical channels and transport channels
Multiplexing of MAC SDUs coming from one or more logical channels (Multiplexing of MAC SDUs from one or different logical channels onto transport blocks (TB) to be delivered to the physical layer on transport channels)
Demultiplexing of MAC SDUs to one or more logical channels (demultiplexing of MAC SDUs to one or different logical channels from transport blocks (TB) delivered from the physical layer on transport channels)
Scheduling information reporting
Error correction through HARQ
Logical channel prioritization
Priority handling between overlapping resources of one UE
Radio resource selection
Packet filtering
Priority handling between uplink transmission and sidelink transmission for a given UE
Sidelink channel state information (CSI) reporting

The PC5 or Uu PHY layer 516, 524, 528 or 536 may compose OFDM symbols from higher layer data through coding and modulation, convert them into an RF band signal, and transmit it through an antenna. Also, the PC5 or Uu PHY layer 516, 524, 528 or 536 may demodulate and decode received OFDM symbols and forward the result to a higher layer.

In U2N relaying, transmission between the remote UE 510 and the relay UE 520 may be performed through the PC5 relay RLC channel 540. Transmission between the relay UE 520 and the gNB 530 may be performed through the Uu relay RLC channel 550.

For uplink data transfer of U2N relaying, if the SRAP SDU (service data unit) received from the higher layer does not belong to signaling radio bearer 0 (SRB0), the PC5-SRAP 513 of the remote UE 510 may determine the UE ID corresponding to the relay UE 520, which is received from the gNB 530. If the SRAP SDU received from the higher layer belongs to an SRB, the PC5-SRAP 513 of the remote UE 510 may determine the BEARER ID to be the same as the SRB ID. If the SRAP SDU received from the higher layer belongs to a DRB, the PC5-SRAP 513 of the remote UE 510 may determine the BEARER ID to be the DRB ID minus 1. The PC5-SRAP 513 may construct an SRAP data PDU (protocol data unit) by combining an SRAP header including UE ID and BEARER ID information with the SRAP data SDU.

If the SRAP SDU received from the higher layer belongs to SRB0, the PC5-SRAP 513 of the remote UE 510 may construct an SRAP data PDU such as an SRAP data SDU without an SRAP header. If the SRAP data PDU does not belong to SRB0, the SRAP data PDU may be delivered to the egress PC5 relay RLC channel configured to transmit the SRB or DRB received from the gNB. Here, one or more SRBs or one or more DRBs may be configured to be transmitted using a single PC5 relay RLC channel, or may be configured to be transmitted using different PC5 relay RLC channels. If the SRB and DRB have the same BEARER ID, the SRB and DRB may be differentiated by being transmitted using different PC5 relay RLC channels. If the SRAP data PDU belongs to SRB0 or SRB1, the SRAP data PDU may be delivered to the egress PC5 relay RLC channel indicated by the specified configuration. The specified configuration may be as shown in Table 1.

TABLE 1

| | | | |
|---|---|---|---|
| Name | Value | Semantics description | Ver |

Parameters that are specified for NR sidelink L2 U2N Relay
operations, which is used for the PC5 Relay RLC channel for
Remote UE's SRB0 message transmission/reception. The PC5
Relay RLC channel using this configuration is named as SL-RLC0.

| | | |
|---|---|---|
| RLC configuration | | AM |
| >sn-FieldLength | 12 | |
| >t-Reassembly | Undefined | Selected by the receving UE, up |
| | | to UE implementation |
| >t-PollRetransmit | Undefined | Selected by the transmitting UE, |
| | | up to UE implementation |
| >pollPDU | Undefined | Selected by the transmitting UE, |
| | | up to UE implementation |
| >pollByte | Undefined | Selected by the transmitting UE, |
| | | up to UE implementation |
| >maxRetxThreshold | Undefined | Selected by the receving UE, up |
| | | to UE implementation |
| >t-StatusProhibit | Undefined | Selected by the receving UE, up |
| | | to UE implementation |
| >logicalChannelIdentity | 56 | |
| MAC configuration | | |
| >priority | 1 | |
| >proritisedBitRate | Inifinity | |
| >logicalChannelGroup | 0 | |
| >schedulingRequestId | 0 | The scheduling request |
| | | configuration with this value |
| | | is applicable for this SCCH |
| | | if configured by the |
| | | network. The scheduling |
| | | request configuration is not |
| | | applicable to L2 U2N |
| | | Remote UE. |
| >sl-HARQ-FeedbackEnabled | | Selected by the transmiting |
| | | UE, up to UE |
| | | implementation |

Parameters of the PC5 Relay RLC Channel used for Remote UE's SRB1
RRC message transmission and reception. The PC5 Relay RLC Channel
using this configuration is named as SL-RLC1.

| | | |
|---|---|---|
| RLC configuration | | AM |
| >sn-FieldLength | 12 | |
| >t-Reassembly | Undefined | Selected by the receving UE, up |
| | | to UE implementation |
| >t-PollRetransmit | Undefined | Selected by the transmitting UE, |
| | | up to UE implementation |
| >pollPDU | Undefined | Selected by the transmitting UE, |
| | | up to UE implementation |
| >pollByte | Undefined | Selected by the transmitting UE, |
| | | up to UE implementation |
| >maxRetxThreshold | Undefined | Selected by the transmitting UE, |
| | | up to UE implementation |
| >t-StatusProhibit | Undefined | Selected by the receiving UE, up |
| | | to UE implementation |
| >logicalChannelIdentity | 57 | |
| MAC configuration | | |
| >priority | 1 | |
| >proritisedBitRate | Inifinity | |
| >logicalChannelGroup | 0 | |
| >schedulingRequestId | 0 | The scheduling request |
| | | configuration with this value |
| | | is applicable for this SCCH |
| | | if configured by the network. |

The PC5-SRAP 521 of the relay UE 520 may forward the SRAP data PDU received via the PC5 relay RLC channel to the Uu-SRAP 525. If the Uu-SRAP 525 of the relay UE 520 receives the SRAP data PDU via SL-RLC0, it may determine the UE ID corresponding to the remote UE 510, which is received from the gNB 530. The Uu-SRAP 525 of the relay UE 520 may determine the BEARER ID to be 0. The Uu-SRAP 525 may construct an SRAP data PDU (protocol data unit) by combining an SRAP header including UE ID and BEARER ID information with an SRAP data SDU. The Uu-SRAP 525 of the relay UE 520 may deliver the SRAP data PDU to an egress Uu relay RLC channel configured to transmit SRBs or DRBs configured by the gNB 530. Here, one or more SRBs or one or more DRBs may be configured to be transmitted using a single Uu relay RLC channel, or may be configured to be transmitted using different Uu relay RLC channels. If the SRB and DRB have the same BEARER ID, the SRB and DRB may be differentiated by being transmitted using different PC5 relay RLC channels.

For downlink transfer of U2N relaying, the Uu-SRAP 525 of the relay UE 520 may forward the received SRAP data packet to the PC5-SRAP 521. The PC5-SRAP 521 of the relay UE 520 may determine the remote UE 510 corresponding to the UE ID included in the SRAP header, and deliver the SRAP data PDU to the egress PC5 relay RLC channel corresponding to the BEARER ID configured to transmit the SRB or DRB set by the gNB 530. Here, one or more SRBs or one or more DRBs may be configured to be transmitted using a single Uu relay RLC channel, or may be configured to be transmitted using different Uu relay RLC channels. If the SRB and DRB have the same BEARER ID, the SRB and DRB may be differentiated by being transmitted using different Uu relay RLC channels

If the SRAP data PDU belongs to SRB0, the PC5-SRAP 521 of the relay UE 520 may remove the SRAP header from the SRAP data PDU. If the SRAP data PDU belongs to SRB0 or SRB1, the SRAP data PDU may be delivered to the egress PC5 relay RLC channel indicated by the specified configuration as shown in Table 1. If the SRAP data PDU received through the PC5-SRAP 513 of the remote UE 510 belongs to SRB0, the SRAP SDU may be transferred to the Uu-RRC 511.

If the received SRAP data PDU does not belong to SRB0 and a radio bearer (RB) of the remote UE 510 is configured by the gNB 530, the PC5-SRAP 513 of the remote UE 510 may remove the SRAP header and forward the resulting SRAP SDU to the Uu-PDCP 512 of the remote UE 510 corresponding to the BEARER ID (BEARER ID plus 1 in case of a DRB) included in the SRAP header. If the received SRAP data PDU does not belong to SRB0 and no RB is configured for the remote UE 510 by the gNB 530, the PC5-SRAP 513 of the remote UE 510 may remove the SRAP header and forward the resulting SRAP SDU to the Uu-PDCP 512 corresponding to SRB1.

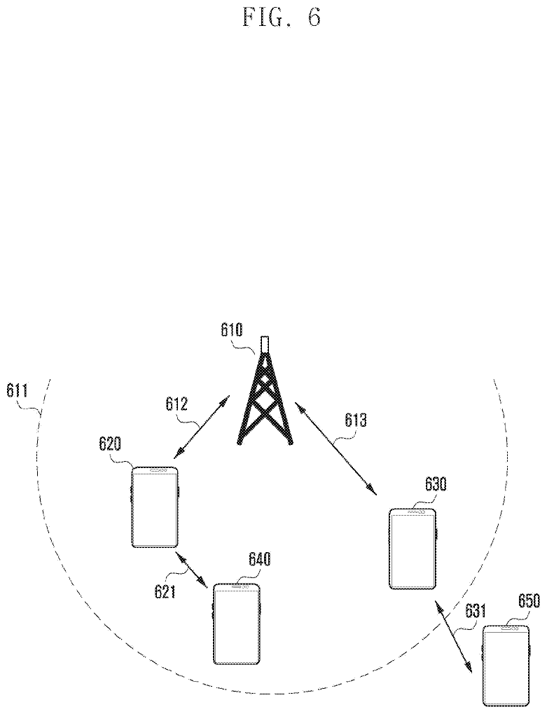

FIG. 6 is a diagram illustrating an example of scenarios for sidelink U2N relay communication in a wireless communication system according to an embodiment of the disclosure.

With reference to FIG. 6, U2N relay UEs 620 and 630 capable of supporting operations for UE-to-network (U2N) relaying is illustrated. The U2N Relay UEs 620 and 630 may be in an in-coverage (IC) situation, i.e., located within the coverage 611 of the gNB 610. Additionally, there are U2N remote UEs 640 and 650 capable of supporting operations of a U2N remote UE. The U2N remote UEs 640 and 650 may be in an in-coverage (IC) situation, i.e., located within the coverage 611 of the gNB 610, or in an out-of-coverage (OOC) situation, i.e., located outside the coverage 611 of the gNB 610. The U2N remote UEs 640 and 650 may be sidelink UEs.

Additionally, in FIG. 6, the uplink and downlink 612 and 613 between the gNB 610 and UEs 620 and 630 may be referred to as the Uu interface, and the transmission link or reception link 621 and 631 between sidelink UEs 640 and 650 may be referred to as the PC5 interface. In the following description, the uplink or downlink 612 or 613 and the Uu interface may be used interchangeably, and the transmission link or reception link 621 or 631 between sidelink UEs and the PC5 interface may be used interchangeably. If the data transmitted from the gNB 610 to the U2N relay UE 620 or 630 via the Uu link 612 or 613 is data to be relayed to the U2N remote UE 640 or 650, the U2N relay UE 620 or 630 may transfer the data to the U2N remote UE 640 or 650 via the PC5 link 621 or 631 according to the configuration of the gNB 610. Also, if the data transmitted from the U2N remote UE 640 or 650 to the U2N relay UE 620 or 630 via the PC5 link 621 or 631 is data to be relayed to the gNB 610, the U2N relay UE 620 or 630 may transfer the data transmitted from the U2N remote UE 640 or 650 to the gNB 610 via the Uu link 612 or 613. The uplink or downlink transfer of the U2N remote UE 640 or 650 or relay UE 620 or 630 may be the same as in the example of FIG. 5.

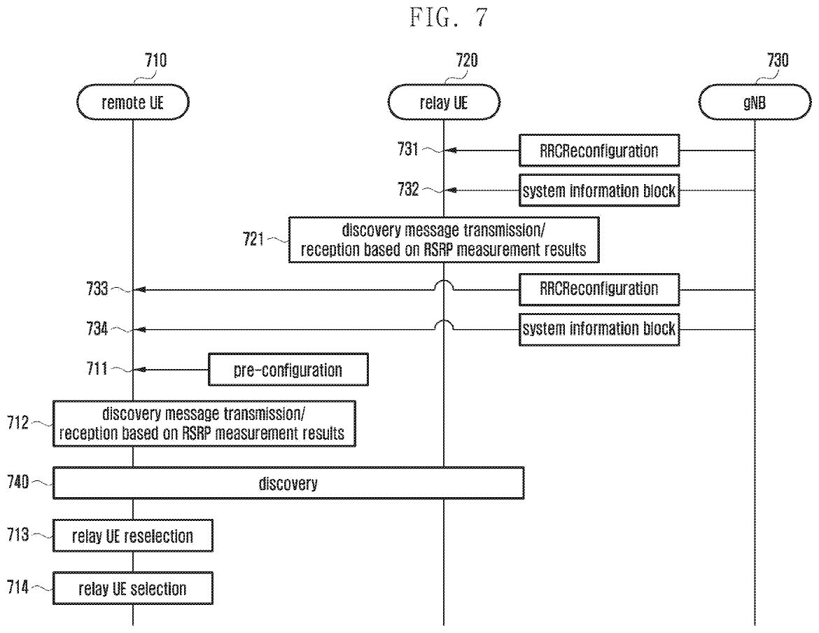

FIG. 7 is a diagram illustrating signal flows in which threshold values are set for a U2N relay UE and a U2N remote UE, and the U2N remote UE selects or reselects a U2N relay UE in a wireless communication system according to an embodiment of the disclosure.

With reference to FIG. 7, the gNB 730 may transmit a dedicate configuration for sidelink communication and a dedicated configuration for L2 U2N relaying to the L2 U2N relay UE 720 through an RRC (e.g., RRCReconfiguration) message 731.

In addition, the gNB 730 may broadcast a system information block (SIB) message 732, or transmit a SIB message 732 to the L2 U2N relay UE 720 in response to a SIB request therefrom. The SIB message 732 may indicate whether the gNB 730 supports layer 2 (L2) U2N relaying, and include a common configuration for sidelink communication and/or a common configuration for L2 U2N relaying.

The common configuration and/or designated configuration for sidelink communication may include a Tx (transmission) pool and an Rx (reception) pool, which indicate resources for transmitting and receiving sidelink data, and a discovery Tx pool and a discovery Rx pool, which indicate resources for transmitting and receiving sidelink discovery messages. The common configuration and/or designated configuration for L2 U2N relaying may include settings (e.g., sl-RelayUE-Config) that specify conditions for transmitting and receiving discovery messages for the UE 720 supporting operations as an L2 U2N relay UE.

The discovery message transmission and reception (721) of the L2 U2N relay UE may be performed by utilizing resources of the discovery Tx pool and discovery Rx pool if they are configured, and may be performed by utilizing the Tx pool and Rx pool for sidelink data if they are not configured. The discovery message transmission and reception (721) of the L2 U2N relay UE may be performed using a specific resource pool described or may be performed using resources not specified in the disclosure, and in the following description, it is assumed that the transmission resource pool and reception resource pool of the UE transmitting the discovery message and the UE receiving the discovery message are the same.

The L2 U2N relay UE 720 may determine whether to transmit or receive a discovery message (721) for providing information to a neighbor L2 U2N remote UE 710 seeking U2N relaying service reception, based on the RSRP (reference signal received power) measurement results as to the serving gNB. The RSRP criterion may be determined based on the RRC (e.g., RRCReconfiguration) message 731 or SIB message 732 received from the gNB 730. Specifically, if the value obtained by considering the hysteresis in the RSRP measurement result as to the gNB 730 is lower than the threshold, the RRC (e.g., RRCReconfiguration) message 731 or SIB message 732 may include information about at least one of threshHighRelay or hystMaxRelay, so that a discovery message can be transmitted or received. Additionally, if the value obtained by considering the hysteresis in the RSRP measurement result as to the gNB 730 is lower than the threshold, the RRC (e.g., RRCReconfiguration) message 731 or SIB message 732 may include information about at least one of threshLowRelay or hystMinRelay, so as not to transmit or receive a discovery message (721).

The gNB 730 may transmit a designated configuration for sidelink communication and a designated configuration for L2 U2N relaying to the L2 U2N remote UE 710 via an RRC (e.g., RRCReconfiguration) message 733.

The gNB 730 may transmit a system information block (SIB) message 734 to the L2 U2N remote UE 710 by broadcasting the message or by transmitting the SIB message 734 in response to a SIB request from the UE. The SIB message 734 may indicate whether the gNB 730 supports layer 2 (L2) U2N relaying, and include a common configuration for sidelink communication and/or a common configuration for L2 U2N relaying. In addition, if the L2 U2N remote UE 710 is in an OOC (out-of-coverage) state, it may use the settings for sidelink communication and the settings for L2 U2N relaying that can be included in the pre-configuration 711 that is set in advance.

The common configuration, dedicated configuration, and pre-configuration 711 for sidelink communication may include a Tx pool and an Rx pool that indicate resources for transmitting and receiving sidelink data, and a discovery Tx pool and a discovery Rx pool that indicate resources for transmitting and receiving a sidelink discovery. The common configuration and/or dedicated specific configuration for L2 U2N relaying may include settings (e.g., sl-RemoteUE-Config) that specify conditions for transmitting and receiving discovery messages (712) for the UE 710 that supports operations of a U2N remote UE. The RSRP criteria as to the serving gNB 730 for the U2N remote UE 710 to transmit or receive a discovery message (712) may be set in the L2 U2N remote UE 710 via the RRC (e.g., RRCReconfiguration) message 733 or SIB message 734 received from the gNB 730. Specifically, if the value obtained by considering the hysteresis in the RSRP measurement result as to the gNB 730 is lower than the threshold, to enable transmission or reception of a discovery message (712), the RRC (e.g., RRCReconfiguration) message 733 or SIB message 734 may include thresholdHighRemote and hystMaxRemote. The L2 U2N remote UE 710 when in the OOC state may always transmit and receive a discovery message (712).

If there is no serving cell or if the RSRP measurement result as to the currently camped gNB 730 is lower than thresHighRemote included in the configuration (sl-RemoteUE-Config) that specifies the conditions for transmitting and receiving a discovery message, the L2 U2N remote UE 710 may initiate a sidelink discovery procedure 740 if at least one of the following conditions is satisfied:
L2 U2N relay UE 720 is not selected;
SL-RSRP (sidelink reference signal received power) of selected L2 U2N relay UE 720 is available and its value is lower than sl-RSRP-Thresh;
SL-RSRP of selected L2 U2N relay UE 720 is not available, and SD-RSRP (sidelink discovery reference signal received power) of selected L2 U2N relay UE 720 is lower than sl-RSRP-Thresh. Here, which of SL-RSRP and SD-RSRP to use depends on UE implementation, and if SD-RSRP is used, a discovery procedure 740 between the L2 U2N remote UE 710 and the L2 U2N relay UE 720 may be initiated;
Selected L2 U2N relay UE 720 has been indicated not to be used by higher layer;
PC5-RRC connection associated with selected L2 U2N relay UE 720 has been indicated to be released by higher layer; or
A sidelink radio link failure has been detected on the PC5-RRC associated with selected L2 U2N relay UE 720.

SL-RSRP is a value measured in dBm on the demodulation reference signal (DMRS) included in the physical sidelink control channel (PSCCH) and physical sidelink shared channel (PSSCH) for sidelink data transmission.

SD-RSRP is a value measured in dBm on the demodulation reference signal (DMRS) included in the physical sidelink control channel (PSCCH) and physical sidelink shared channel (PSSCH) for transmitting a sidelink discovery message.

The L2 U2N remote UE 710 may perform layer 3 filtering before using SD-RSRP measured for candidate L2 U2N relay UEs 720 discovered by the sidelink discovery procedure 740. Specifically, for SD-RSRP measured on a UE with the same U2N relay UE ID, if the L2 U2N remote UE 710 is in RRC IDLE or INACTIVE, the sl-FilterCoefficientRSRP value transmitted via SIB (specifies L3 filter coefficient for SL communication/discovery RSRP measurement results from L1 filter) may be used; if it is in RRC CONNECTED, the st-FilterCoefficientRSRP value transmitted via sl-ConfigDedicatedNR may be used; and if it is in OOC, the pre-configured sl-FilterCoefficientRSRP value may be used. Thereafter, if layer 3 filtered SD-RSRP is greater than the value obtained by adding sl-HystMin to sl-RSRP-Thresh (indicates the threshold of SL communication/discovery RSRP for a U2N remote UE to perform relay UE selection/reselection and sl-HystMin, where sl-RSRP-Thresh and sl-HystMin are values set by the gNB 730 or pre-configuration 711, the L2 U2N remote UE 710 may determine that the AS (access stratum) layer criteria are satisfied. Thereafter, the higher layer of the L2 U2N remote UE 710 may select an L2 U2N relay UE that satisfies the AS layer criteria and higher layer criteria. If the L2 U2N relay UE 720 is selected by the L2 U2N remote UE 710 and satisfies at least one of the above conditions, this may be called L2 U2N relay UE reselection 713; and if the L2 U2N relay UE 720 is not selected yet by the L2 U2N remote UE 710 and satisfies at least one of the above conditions, this may be called L2 U2N relay UE selection 714.

To adjust the transmission power (Tx power) of sidelink data, the gNB 730 may adjust the Tx power for each resource pool by using parameters such as SL-PowerControl illustrated in Table 2.

TABLE 2
SL-PowerControl-r16 ::= SEQUENCE {

| | |
|---|---|
| sl-MaxTransPower-r16 | INTEGER (−30..33), |
| sl-Alpha-PSSCH-PSCCH-r16 | ENUMERATED {alpha0, alpha04, alpha05, alpha06, |
| alpha07, alpha08, alpha09, alpha1} | OPTIONAL, -- Need M |
| dl-Alpha-PSSCH-PSCCH-r16 | ENUMERATED {alpha0, alpha04, alpha05, alpha06, |
| alpha07, alpha08, alpha09, alpha1} | OPTIONAL, -- Need S |
| sl-P0-PSSCH-PSCCH-r16 | INTEGER (−16..15) |

OPTIONAL, -- Need S

| | |
|---|---|
| dl-P0-PSSCH-PSCCH-r16 | INTEGER (−16..15) |

OPTIONAL, -- Need M

| | |
|---|---|
| dl-Alpha-PSFCH-r16 | ENUMERATED {alpha0, alpha04, alpha05, alpha06, |
| alpha07, alpha08, alpha09, alpha1} | OPTIONAL, -- Need S |
| dl-P0-PSFCH-r16 | INTEGER (−16..15) |

```
OPTIONAL, -- Need M
  ...,
  [[
```

| | |
|---|---|
| dl-P0-PSSCH-PSCCH-r17 | INTEGER (−202..24) |

OPTIONAL, -- Need M

| | |
|---|---|
| sl-P0-PSSCH-PSCCH-r17 | INTEGER (−202..24) |

OPTIONAL, -- Need S

| | |
|---|---|
| dl-P0-PSFCH-r17 | INTEGER (−202..24) |

OPTIONAL -- Need M
]]
}

In addition, to adjust the Tx power based on the channel busy ratio (CBR) and the priority of sidelink data, the gNB 730 may adjust the Tx power for each resource pool based on the CBR and/or the priority of sidelink data by using parameters such as SL-CBR-PriorityTxConfigList, SL-CBR-CommonTxConfigList, SL-PSSCH-TxConfigList illustrated in Table 3.

TABLE 3

- SL-CBR-PriorityTxConfigList

The IE SL-CBR-PriorityTxConfigList indicates the mapping between PSSCH transmission
parameter (such as MCS, PRB number, retransmission number, CR limit) sets by using the
indexes of the configurations provided in sl-CBR-PSSCH-TxConfigList, CBR ranges by an
index to the entry of the CBR range configuration in sl-CBR-RangeConfigList, and priority
ranges. It also indicates the default PSSCH transmission parameters to be used when CBR
measurement results are not available, and MCS range for the MCS tables used in the
resource pool.

SL-CBR-PriorityTxConfigList information element

-- ASN1START
-- TAG-SL-CBR-PRIORITYTXCONFIGLIST-START
SL-CBR-PriorityTxConfigList-r16 ::= SEQUENCE (SIZE (1..8)) OF SL-PriorityTxConfigIndex-
r16
SL-CBR-PriorityTxConfigList-v1650 ::= SEQUENCE (SIZE (1..8)) OF SL-
PriorityTxConfigIndex-v1650

| SL-PriorityTxConfigIndex-r16 ::= | | SEQUENCE { |
|---|---|---|
| sl-PriorityThreshold-r16 | | INTEGER (1..8) |
| OPTIONAL, | -- Need M | |
| sl-DefaultTxConfigIndex-r16 | | INTEGER (0..maxCBR-Level-1-r16) |
| OPTIONAL, | -- Need M | |
| sl-CBR-ConfigIndex-r16 | | INTEGER (0..maxCBR-Config-1-r16) |
| OPTIONAL, | -- Need M | |
| sl-Tx-ConfigIndexList-r16 | | SEQUENCE (SIZE (1..maxCBR-Level-r16)) OF |
| SL-TxConfigIndex-r16 | OPTIONAL | -- Need M |

}

| SL-PriorityTxConfigIndex-v1650 ::= | | SEQUENCE { |
|---|---|---|
| sl-MCS-RangeList-r16 | | SEQUENCE (SIZE (1..maxCBR-Level-r16)) OF |
| SL-MinMaxMCS-List-r16 | OPTIONAL | -- Need M |

}

| | |
|---|---|
| SL-TxConfigIndex-r16 ::= | INTEGER (0..maxTxConfig-1-r16) |

-- TAG-SL-CBR-PRIORITYTXCONFIGLIST-STOP
-- ASN1STOP

- SL-CBR-CommonTxConfigList

The IE SL-CBR-CommonTxConfigList indicates the list of PSSCH transmission parameters
(such as MCS, sub-channel number, retransmission number, CR limit) in sl-CBR-PSSCH-
TxConfigList, and the list of CBR ranges in sl-CBR-RangeConfigList, to configure
congestion control to the UE for sidelink communication.

SL-CBR-ConumnonTxConfigList information element

-- ASN1START
-- TAG-SL-CBR-COMMONTXCONFIGLIST-START

| | |
|---|---|
| SL-CBR-CommonTxConfigList-r16 ::= | SEQUENCE { |
| sl-CBR-RangeConfigList-r16 | SEQUENCE (SIZE (1..maxCBR-Config-r16)) |
| OF SL-CBR-LevelsConfig-r16 | OPTIONAL, -- Need M |
| sl-CBR-PSSCH-TxConfigList-r16 | SEQUENCE (SIZE (1..maxTxConfig-r16)) OF |
| SL-CBR-PSSCH-TxConfig-r16 | OPTIONAL -- Need M |

}

| | |
|---|---|
| SL-CBR-LevelsConfig-r16 ::= | SEQUENCE (SIZE (1..maxCBR-Level-r16)) OF SL- |

CBR-r16

| | |
|---|---|
| SL-CBR-PSSCH-TxConfig-r16 ::= | SEQUENCE { |
| sl-CR-Limit-r16 | INTEGER(0..10000) |

| | |
|---|---|
| OPTIONAL, | -- Need M |

| | |
|---|---|
| sl-TxParameters-r16 | SL-PSSCH-TxParameters-r16 |

| | |
|---|---|
| OPTIONAL | -- Need M |

}

| | |
|---|---|
| SL-CBR-r16 ::= | INTEGER (0..100) |

-- TAG-SL-CBR-COMMONTXCONFIGLIST-STOP
-- ASN1STOP

- SL-PSSCH-TxConfigList

The IE SL-PSSCH-TxConfigList indicates PSSCH transmission parameters. When lower
layers select parameters from the range indicated in IE SL-PSSCH-TxConfigList, the UE
considers both configurations in IE SL-PSSCH-TxConfigList and the CBR-dependent
configurations represented in IE SL-CBR-PriorityTxConfigList. Only one IE SL-PSSCH-
TxConfig is provided per SL-TypeTxSync.

SL-PSSCH-TxConfigList information element

-- ASN1START
-- TAG-SL-PSSCH-TXCONFIGLIST-START

| | |
|---|---|
| SL-PSSCH-TxConfigList-r16 ::= | SEQUENCE (SIZE (1..maxPSSCH-TxConfig-r16)) OF SL- |

PSSCH-TxConfig-r16

| | |
|---|---|
| SL-PSSCH-TxConfig-r16 ::= | SEQUENCE { |
| sl-TypeTxSync-r16 | SL-TypeTxSync-r16 |

| | |
|---|---|
| OPTIONAL, | -- Need R |

| | |
|---|---|
| sl-ThresUE-Speed-r16 | ENUMERATED {kmph60, kmph80, kmph100, |

kmph120,

kmph140, kmph160, kmph180,

kmph200},

| | |
|---|---|
| sl-ParametersAboveThres-r16 | SL-PSSCH-TxParameters-r16, |
| sl-ParametersBelowThres-r16 | SL-PSSCH-TxParameters-r16, |

```
  ...,
  [[
```

| | |
|---|---|
| sl-ParametersAboveThres-v1650 | SL-MinMaxMCS-List-r16 |

| | |
|---|---|
| OPTIONAL, | -- Need R |

| | |
|---|---|
| sl-ParametersBelowThres-v1650 | SL-MinMaxMCS-List-r16 |

| | |
|---|---|
| OPTIONAL | -- Need R |

]]
}

| | |
|---|---|
| SL-PSSCH-TxParameters-r16 ::= | SEQUENCE { |
| sl-MinMCS-PSSCH-r16 | INTEGER (0..27), |
| sl-MaxMCS-PSSCH-r16 | INTEGER (0..31), |
| sl-MinSubChannelNumPSSCH-r16 | INTEGER (1..27), |
| sl-MaxSubchannelNumPSSCH-r16 | INTEGER (1..27), |
| sl-MaxTxTransNumPSSCH-r16 | INTEGER (1..32), |
| sl-MaxTxPower-r16 | SL-TxPower-r16 |

| | |
|---|---|
| OPTIONAL | -- Cond CBR |

}
-- TAG-SL-PSSCH-TXCONFIGLIST-STOP
-- ASN1STOP

Measurement results for SL-RSRP of the L2 U2N relay UE 720 measured by the L2 U2N remote UE 710 may differ from those for SD-RSRP of the L2 U2N relay UE 720 measured by the L2 U2N remote UE 710 due to the parameters for Tx power adjustment described above. Additionally, if the resource pool for sidelink data transmission and the resource pool for sidelink discovery message transmission are different, the measurement results for SL-RSRP of the L2 U2N relay UE 720 measured by the L2 U2N remote UE 710 may also differ from those for SD-RSRP of the L2 U2N relay UE 720 measured by the L2 U2N remote UE 710. Consequently, when SL-RSRP and SD-RSRP used for L2 U2N relay UE reselection 713 are used as a single threshold (sl-RSRP-Thresh), the gNB 730 has set the threshold on the assumption that relay UE reselection 713 is performed based on SL-RSRP, but the L2 U2N remote UE 710 may actually perform relay UE reselection 713 based on SD-RSRP; if the measurement values for SL-RSRP and SD-RSRP of the L2 U2N relay UE 720 measured by the L2 U2N remote UE 710 are different, a problem may occur in which the L2 U2N remote UE 710 performs relay UE reselection 713 based on a measurement scheme different from the intention of the gNB 730 (e.g., threshold value intended for SL-RSRP or threshold value intended for SD-RSRP).

As an embodiment, this problem may be solved by using at least one of the following four options:
Option 1: when the L2 U2N remote UE 710 evaluates relay UE reselection criteria, it may compare only SD-RSRP of the serving relay UE with sl-RSRP-Thresh. That is, this may be expressed as the following condition: “If the UE has a selected NR sidelink U2N relay UE, and the SD-RSRP of the currently selected U2N relay UE is below sl-RSRP-Thresh”. In addition, sl-FilterCoefficientRSRP and sl-RSRP-Thresh set by the gNB 730 in SL-ReselectionConfig may be expressed as follows: “sl-FilterCoefficientRSRP: specifies L3 filter coefficient for SL discovery RSRP measurement results from L1 filter”, “sl-RSRP-Thresh: indicates the threshold of SL discovery RSRP for a U2N remote UE to perform relay UE selection/reselection”
Option 2: if the L2 U2N remote UE 710 utilizes SD-RSRP of the serving relay UE, sl-RSRP-Thresh to be used may be newly defined. For example, it may be represented as sl-SD-RSRP-Thresh, and the RSRP range may be expressed as SL-RSRP-Range (values greater than or equal to 0 and less than or equal to 13, where 0 represents negative infinity, 1 represents-115 dBm, 2 represents-110 dBm, . . . , 12 represents-60 dBm, and 13 represents positive infinity) or as RSRP-Range (actual value is IE value-156 dBm). Newly defined sl-SD-RSRP-Thresh may be used under the following conditions.
SL-RSRP of selected L2 U2N relay UE 720 is not available, and the SD-RSRP value of selected L2 U2N relay UE 720 is lower than sl-SD-RSRP-Thresh.
if the UE has a selected NR sidelink U2N relay UE, and SL-RSRP of the currently selected NR sidelink U2N relay UE is not available, and SD-RSRP of the currently selected U2N relay UE is below sl-SD-RSRP-Thresh;
Option 3: the L2 U2N remote UE 710 may preferentially utilize SD-RSRP of the serving relay UE. In other words, instead of using SD-RSRP when SL-RSRP is unavailable, SL-RSRP may be used when SD-RSRP is unavailable. If SD-RSRP is not measured for a specific period of time (e.g., value set by the gNB in units of milliseconds (ms) or seconds(s)), SL-RSRP may be used.
Option 4: if the L2 U2N remote UE 710 can use both SL-RSRP and SD-RSRP of the serving relay UE (e.g., if only SL-RSRP is available, the discovery procedure 740 may be performed to measure SD-RSRP), the higher or lower value among SL-RSRP and SD-RSRP may be used. For example, the L2 U2N remote UE 710 may select and use the higher value or lower value among SL-RSRP or SD-RSRP of the serving relay UE according to UE implementation, or the gNB 730 may set a configuration to utilize the higher value or lower value.

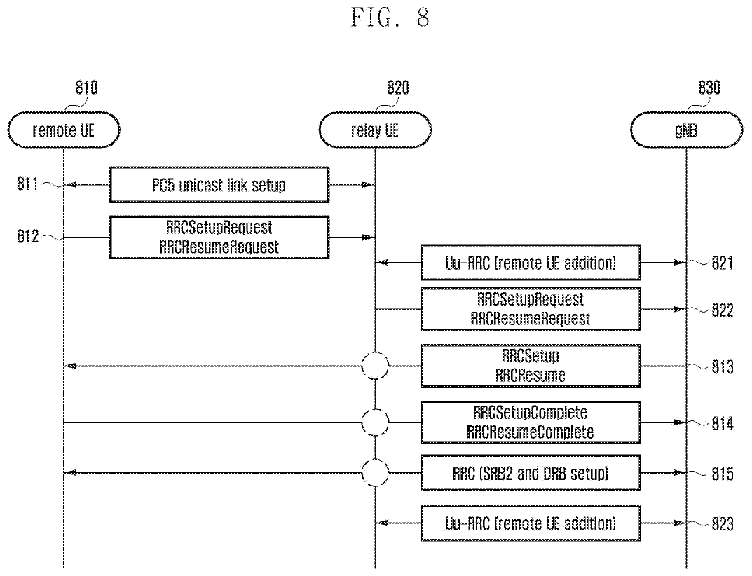

FIG. 8 is a diagram illustrating signal flows in which a U2N remote UE selects or reselects a U2N relay UE and connects to the network in a wireless communication system according to an embodiment of the disclosure.

With reference to FIG. 8, to receive a sidelink relay service from the gNB 830 via a selected or reselected L2 U2N relay UE 820, the L2 U2N remote UE 810 may establish a PC5 unicast link with the L2 U2N relay UE 820 (811). Here, the criteria for selecting or reselecting the L2 U2N relay UE 820 may follow the illustration of FIG. 7.

To connect to the gNB, the L2 U2N remote UE 810 may transmit RRCSetupRequest or RRCResumeRequest to the L2 U2N relay UE 820 through the PC5 relay RLC channel SL-RLC0 or SL-RLC1 (812).

Upon receiving a message through SL-RLC0 or SL-RLC1, at step 821, the L2 U2N relay UE 820 may transmit information about the L2 U2N remote UE 810 to the gNB 830, receive a resource pool for communication between the L2 U2N remote UE 810 and the L2 U2N relay UE 820 and a PC5 relay RLC channel configuration to be used for uplink or downlink via relaying between the L2 U2N remote UE 810 and the gNB 830, and receive a Uu relay RLC channel configuration to be used for uplink or downlink via relaying.

At step 822, the L2 U2N relay UE 820 may transmit the RRCSetupRequest or RRCResumeRequest received at step 812 from the L2 U2N remote UE 810 to the gNB 830 through the Uu relay RLC channel established at step 821.

At step 813, the base station 830 may transmit an RRCSetup or RRCResume message for an RRC configuration of the L2 U2N remote UE 810 through the L2 U2N relay UE 820, and if the L2 U2N remote UE 810 normally applies the configuration received at step 813 from the gNB 830, at step 814, it may notify this to the gNB 830 through the L2 U2N relay UE 820 by using an RRCSetupComplete or RRCResumeComplete message.

At step 815, the gNB 830 and the L2 U2N remote UE 810 may establish and configure SRB2 and DRBs through an RRC message (e.g., RRCReconfiguration). At step 823, the gNB 830 may set up SRAP to the L2 U2N relay UE 820 through an RRC message (e.g., RRCReconfiguration) so as to enable the L2 U2N relay UE 820 to forward the SRB2 and DRBs of the L2 U2N remote UE 810 set up at step 815 through the PC5 relay RLC channel and the Uu relay RLC channel.

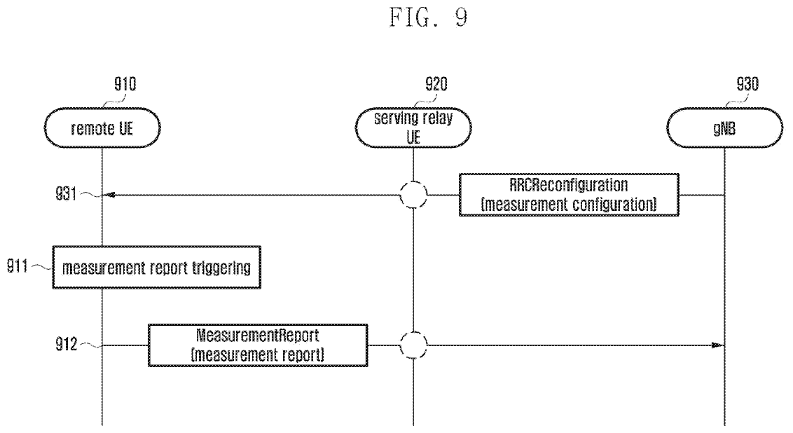

FIG. 9 is a diagram illustrating signal flows in which the base station configures signal measurements and measurement reporting to a U2N remote UE in a wireless communication system according to an embodiment of the disclosure.

With reference to FIG. 9, it is assumed that the L2 U2N remote UE 910 is indirectly (i.e., via L2 U2N relay UE 920) connected to the gNB 930 via the L2 U2N relay UE 920. The connection of the L2 U2N remote UE 910 to the gNB 930 may be established via the L2 U2N relay UE 920 according to the example of FIG. 8, or may be established through path switching.

The gNB 930 may initiate measurement configuration by transmitting an RRCReconfiguration message to the L2 U2N remote UE 910 (931). The configuration transmitted at this time may be composed of at least one measId (the IE MeasId is used to identify a measurement configuration, i.e., linking a measurement object and a reporting configuration), measObjectld (the IE MeasObjectId is used to identify a measurement object configuration), and reportConfigld (the IE ReportConfigId is used to identify a measurement reporting configuration). measId refers to the measurement configuration, measObjectld refers to the intra or inter frequency for measurement, and reportConfigID refers to the measurement reporting configuration. Parameters included in the measurement configuration may be based on 3GPP TS 38.331.

The measurement report triggering event included in the measurement configuration transmitted to the L2 U2N remote UE 910 may be at least one of the following two events.
Event X1: the measurement value of the serving L2 U2N relay UE is lower than threshold1, and the measurement value of the NR cell is higher than threshold2. Specifically, if condition “serving L2 U2N relay UE's measurement value<(threshold1+hysteresis)” and condition “(NR cell's measurement value+object-specific offset+cell-specific offset−hysteresis)>threshold2” are both satisfied, the entering condition may be determined to be satisfied. Additionally, if at least one of condition “(serving L2 U2N relay UE's measurement value−hysteresis)>threshold1” or condition “(NR cell's measurement value+object specific offset+cell specific offset+hysteresis)>threshold2” is satisfied, the leaving condition may be determined to be satisfied.
Event X2: the measurement value of the serving L2 U2N relay UE is lower than the threshold. Specifically, if condition “serving L2 U2N relay UE's measurement value<(threshold+hysteresis)” is satisfied, the entering condition may be determined to be satisfied. Additionally, if condition “(serving L2 U2N relay UE's measurement value-hysteresis)>threshold” is satisfied, the leaving condition may be determined to be satisfied.

Measurement report triggering 911 of the L2 U2N remote UE 910 may be performed when reportType is eventTriggered and the layer 3 filtered value satisfies the entering or leaving condition of the above-described event (i.e., event X1 or event X2) for a period of timeToTrigger. The measurement method (measurement quantity) for measurement report triggering (911) and the parameters for layer 3 filtering may be configured as shown in Table 4.

TABLE 4

| | |
|---|---|
| MeasTriggerQuantity ::= | CHOICE { |
| rsrp | RSRP-Range, |
| rsrq | RSRQ-Range, |
| sinr | SINR-Range |

}

| | |
|---|---|
| SL-MeasTriggerQuantity-r16 ::= | CHOICE { |
| sl-RSRP-r16 | RSRP-Range, |

...
}

- QuantityConfig

The IE QuantityConfig specifies the measurement quantities and layer 3 filtering coefficients
for NR and inter-RAT measurements.

QuantityConfig information element

-- ASN1START
-- TAG-QUANTITYCONFIG-START

| | |
|---|---|
| QuantityConfig ::= | SEQUENCE { |
| quantityConfigNR-List | SEQUENCE (SIZE (1..maxNrofQuantityConfig)) |
| OF QuantityConfigNR | OPTIONAL, -- Need M |

```
  ...,
  [[
```

| | |
|---|---|
| quantityConfigEUTRA | FilterConfig |

```
OPTIONAL -- Need M
  ]],
  [[
```

| | |
|---|---|
| quantityConfigUTRA-FDD-r16 | QuantityConfigUTRA-FDD-r16 |

OPTIONAL, -- Need M

| | |
|---|---|
| quantityConfigCLI-r16 | FilterConfigCLI-r16 |

OPTIONAL -- Need M
]]
}

| | |
|---|---|
| QuantityConfigNR::= | SEQUENCE { |
| quantityConfigCell | QuantityConfigRS, |
| quantityConfigRS-Index | QuantityConfigRS |

OPTIONAL -- Need M
}

| | |
|---|---|
| QuantityConfigRS ::= | SEQUENCE { |
| ssb-FilterConfig | FilterConfig, |
| csi-RS-FilterConfig | FilterConfig |

}

| | |
|---|---|
| FilterConfig ::= | SEQUENCE { |
| filterCoefficientRSRP | FilterCoefficient |

DEFAULT fc4,

| | |
|---|---|
| filterCoefficientRSRQ | FilterCoefficient |

DEFAULT fc4,

| | |
|---|---|
| filterCoefficientRS-SINR | FilterCoefficient |

DEFAULT fc4
}

| | |
|---|---|
| FilterConfigCLI-r16 ::= | SEQUENCE { |
| filterCoefficientSRS-RSRP-r16 | FilterCoefficient |

DEFAULT fc4,

| | |
|---|---|
| filterCoefficientCLI-RSSI-r16 | FilterCoefficient |

DEFAULT fc4
}

| | |
|---|---|
| QuantityConfigUTRA-FDD-r16 ::= | SEQUENCE { |
| filterCoefficientRSCP-r16 | FilterCoefficient |

DEFAULT fc4,

| | |
|---|---|
| filterCoefficientEcNO-r16 | FilterCoefficient |

DEFAULT fc4
}
-- TAG-QUANTITYCONFIG-STOP
-- ASN1STOP

- SL-QuantityConfig

The IE SL-QuantityConfig specifies the layer 3 filtering coefficients for NR SL RSRP
measurement for a destination.

SL-QuantityConfig information element

-- ASN1START
-- TAG-SL-QUANTITYCONFIG-START

| | |
|---|---|
| SL-QuantityConfig-r16 ::= | SEQUENCE { |
| sl-FilterCoefficientDMRS-r16 | FilterCoefficient |

DEFAULT fc4,
...
}
-- TAG-SL-QuantityConfig-STOP
-- ASN1STOP

The measurement quantity used by the L2 U2N remote UE 910 to measure the signal strength of the serving relay UE 920 may be SL-RSRP. However, if SL-RSRP of the serving relay UE 920 is not available, the SD-RSRP value of the serving relay UE 920 may be used to determine measurement report triggering 911 according to UE implementation. As in the example of FIG. 7, the gNB 930 may set the threshold value on the assumption that the L2 U2N remote UE 910 triggers measurement reporting for the serving relay UE 920 based on SL-RSRP, but the L2 U2N remote UE 910 may actually perform measurement and measurement report triggering 911 based on SD-RSRP; and if the measurement values for SL-RSRP and SD-RSRP of the serving relay UE 720 measured by the L2 U2N remote UE 910 are different, a problem may occur in which the L2 U2N remote UE 710 performs measurement reporting 912 based on a measurement method different from the intention of the gNB 730 (e.g., threshold value intended for SL-RSRP or threshold value intended for SD-RSRP).

The measurement report 912 transmitted by the L2 U2N remote UE 910 to the gNB 930 upon satisfaction of the condition for measurement report triggering 911 may include sl-MeasResultServingRelay (measurement result of serving L2 U2N relay UE), and sl-MeasResult as a lower-level IE of sl-MeasResultServingRelay may include SL-RSRP but may include SD-RSRP according to UE implementation. That is, it may be expressed as follows: “3> set the sl-MeasResult to include the SL-RSRP of the serving L2 U2N relay UE;
NOTE 1: In case of no data transmission from L2 U2N relay UE to L2 U2N remote UE, it is left to UE implementation whether to use SL-RSRP or SD-RSRP when setting the sl-MeasResultServingRelay of the serving L2 U2N relay UE.”

Hence, a problem may occur where the gNB 930 cannot determine whether the measurement result reported by the L2 U2N remote UE 910 is SL-RSRP or SD-RSRP. As an embodiment, this problem may be solved using at least one of the following six options:
Option 1: only SL-RSRP may be used as the measurement quantity for the serving relay UE 920. When evaluating the entering and leaving conditions in the measurement report triggering event X1 or X2, it may be explicitly specified that only SL-RSRP be used. That is, “Mr is the SL-RSRP of the serving L2 U2N relay UE.”, and Mr may be expressed as “Mr is the measurement result of the serving L2 U2N relay UE, not taking into account any offsets.” In addition, only SL-RSRP may be included in the measurement result included in the measurement report 912. That is, “NOTE 1: in the case of no data transmission from the L2 U2N relay UE to the L2 U2N remote UE, it is left to the UE implementation to decide whether to use SL-RSRP or SD-RSRP when setting the sl-MeasResultServingRelay of the serving L2 U2N relay UE.” may be not used.
Option 2: only SD-RSRP may be used as the measurement quantity for the serving relay UE 920. When evaluating the entering and leaving conditions in the measurement report triggering event X1 or X2, it may be explicitly specified that only SD-RSRP be used. That is, it may be expressed as “Mr is the SD-RSRP of the serving L2 U2N relay UE.”, and Mr may be expressed as “Mr is the measurement result of the serving L2 U2N relay UE, not taking into account any offsets.” In addition, only SD-RSRP may be included in the measurement result included in the measurement report 912. That is, it may be expressed as follows: “3> set the sl-MeasResult to include the SD-RSRP of the serving L2 U2N relay UE;”
Option 3: only one of SL-RSRP and SD-RSRP may be used as the measurement quantity in a single measurement report triggering event by adding a lower-level indicator to MeasTriggerQuantity. For example, by configuring sl-SL-RSRP and sl-SD-RSRP indicators as shown in Table 5, sl-SL-RSRP may be used in the entering or leaving condition in case of measurement with SL-RSRP, and sl-SD-RSRP may be used in the entering or leaving condition in case of measurement with SD-RSRP. The existing sl-RSRP may be used in the same way without adding sl-SL-RSRP.

TABLE 5

| | |
|---|---|
| SL-MeasTriggerQuantity-r16 ::= | CHOICE { |
| sl-RSRP-r16 | RSRP-Range, |
| sl-SL-RSRP-r17xy | RSRP-Range, |
| sl-SD-RSRP-r17xy | RSRP-Range, |

...
}

Option 4: only SD-RSRP may be used by adding a threshold for measuring SD-RSRP of the serving relay UE 920, or the thresholds for SL-RSRP and SD-RSRP may be set differently. In case of measurement with SL-RSRP, sl-RSRP may be used as a threshold as in the existing operation. In case of measurement with SD-RSRP, the threshold may be newly defined as follows.

triggerSD-RSRPServingRelay-r17xy RSRP-Range OPTIONAL—Cond X1X2

The threshold to be used in case of measurement with SD-RSRP may be configured if the measurement configuration sets event X1 or X2 as a triggering event.

Option 5: SL-RSRP and/or SD-RSRP may be used as a measurement quantity in a single measurement report triggering event by specifying one or more measurement quantities in MeasTriggerQuantity. For example, as shown in Table 6, by setting sl-SL-RSRP and sl-SD-RSRP indicators in one MeasTriggerQuantity, sl-SL-RSRP may be used in the entering or leaving condition in case of measurement with SL-RSRP, and sl-SD-RSRP may be used in the entering or leaving condition in case of measurement with SD-RSRP. The existing sl-RSRP may be used in the same way without adding sl-SL-RSRP.

TABLE 6

| | |
|---|---|
| SL-MeasTriggerQuantity-r18 ::= | SEQUENCE { |
| sl-RSRP-r16 | RSRP-Range, |
| sl-SL-RSRP-r18 | RSRP-Range, |
| sl-SD-RSRP-r18 | RSRP-Range, |

...
}

Option 6: a new event may be defined that can replace the measurement report triggering event X1 or X2. The new measurement report triggering event may have the form of event X1-1 or event X2-1, for example, as shown in Table 7.

TABLE 7

| | |
|---|---|
| eventX1-1-r18 | SEQUENCE { |
| (1) x1-1-Threshold1-Relay-r18 | SL-MeasTriggerQuantity-r18, |
| (2) x1-1-Threshold1-Relay-r18 | SL-MeasTriggerQuantity-r16, |
| (2) x1-1-Threshold1-1-Relay-r18 | SL-MeasTriggerQuantity-r16, |
| x1-Threshold2-r17 | MeasTriggerQuantity, |
| reportOnLeave-r17 | BOOLEAN, |
| hysteresis-r17 | Hysteresis, |
| timeToTrigger-r17 | TimeToTrigger, |
| useAllowedCellList-r17 | BOOLEAN |

},

| | |
|---|---|
| eventX2-1-r18 | SEQUENCE { |
| (1) x2-1-Threshold-Relay-r18 | SL-MeasTriggerQuantity-r18, |
| (2) x2-1-Threshold-Relay-r18 | SL-MeasTriggerQuantity-r16, |
| (2) x2-1-Threshold-1-Relay-r18 | SL-MeasTriggerQuantity-r16, |
| reportOnLeave-r17 | BOOLEAN, |
| hysteresis-r17 | Hysteresis, |
| timeToTrigger-r17 | TimeToTrigger |

}

For each event, the threshold may be set in the form of (1) or (2). SL-MeasTriggerQuantity-r18 configured as in (1) may simultaneously set thresholds for both SL-RSRP and SD-RSRP with one SL-MeasTriggerQuantity as shown in the example of option 5. Since SL-MeasTriggerQuantity-r16 configured as in (2) can include only one threshold (i.e., sl-RSRP), the threshold for SD-RSRP may be additionally set via x1-1-Threshold1-1-Relay or x2-1-Threshold-1-Relay. In case of measurement with SL-RSRP, sl-RSRP or sl-SL-RSRP in option 5, x1-1-Threshold1-Relay, or x2-1-Threshold-Relay may be used in the entering or leaving condition. In case of measurement with SD-RSRP, sl-SD-RSRP in option 5, x1-1-Threshold1-1-Relay, or x2-1-Threshold-1-Relay may be used in the entering or leaving condition. As an embodiment, the measurement result for the serving relay UE 920 included in the measurement report 912 may include the same measurement result as SL-RSRP or SD-RSRP indicated by SL-MeasTriggerQuantity, or SL-reportQuantityServingRelay that explicitly indicates the measurement result may be newly defined as in Table 8.

TABLE 8

| | |
|---|---|
| reportQuantityServingRelay | SL-MeasReportQuantity-r18 |
| SL-MeasReportQuantity-r18 ::= | CHOICE { |
| sl-SL-RSRP-r18 | BOOLEAN, |
| sl-SD-RSRP-r18 | BOOLEAN, |

...
}

The measurement report 912 transmitted by the L2 U2N remote UE 910 to the gNB 930 may include sl-MeasResultServingRelay, and sl-MeasResult as a lower-level IE of sl-MeasResultServingRelay may include a measurement result value measured with the measurement quantity indicated by reportQuantityServingRelay, a measurement result value measured with the same measurement quantity as SL-MeasTriggerQuantity, SL-RSRP, or SD-RSRP. That is, this may be expressed as (1) to (4) in Table 9.

TABLE 9
“ 2> set the sl-MeasResultServingRelay in accordance with the following:
...
3> set the sl-MeasResult to include the quantity(ies) indicated in the (1)
reportQuantityServingRelay (2) SL-MeasTriggerQuantity (3) SL-RSRP (4) SD-RSRP of the
serving L2 U2N relay UE;”

Additionally, if at least one of the two measurement quantities satisfies the entering or leaving condition, SL-RSRP and SD-RSRP may be included in one sl-MeasResultServingRelay, and SL-RSRP and SD-RSRP may be differentiated by different IEs.

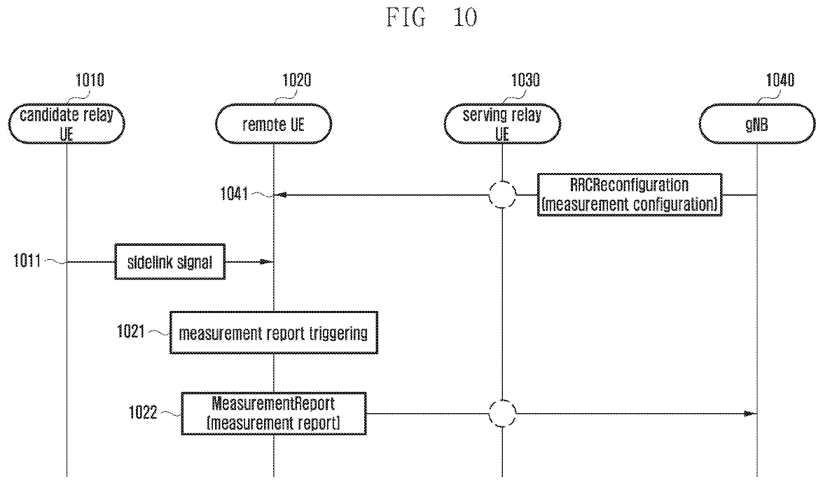

FIG. 10 is a diagram illustrating signal flows in which a U2N remote UE measures signals of a U2N relay UE and a candidate U2N relay UE and reports the measurement results to the base station in a wireless communication system according to an embodiment of the disclosure.

With reference to FIG. 10, it is assumed that an L2 U2N remote UE 1020 is indirectly (i.e., via the L2 U2N relay UE 1030) connected to the gNB 1040 through the L2 U2N relay UE 1030, and a candidate relay UE 1010 is not a serving relay UE for which the L2 U2N remote UE 1020 can measure signal strength. The connection of the L2 U2N remote UE 1020 to the gNB 1040 may be established via the L2 U2N relay UE 1030 according to the example of FIG. 8, or may be established through path switching.

The gNB 1040 may initiate measurement configuration by transmitting an RRCReconfiguration message to the L2 U2N remote UE 1020 (1041). The configuration transmitted at this time may be composed of at least one measId, measObjectld, and reportConfigld. measld refers to the measurement configuration, measObjectld refers to the intra or inter frequency for measurement, and reportConfigII) refers to the measurement reporting configuration. Parameters included in the measurement configuration may be based on 3GPP TS 38.331.

The measurement report triggering event included in the measurement configuration 1041 transmitted to the L2 U2N remote UE 1020 may be at least one of the following two events.
Event Z1: the measurement value of the serving L2 U2N relay UE is lower than threshold1, and the measurement value of the candidate L2 U2N relay UE is higher than threshold2. Specifically, if condition “serving L2 U2N relay UE's measurement value< (threshold1+hysteresis)” and condition “(candidate L2 U2N relay UE's measurement value-hysteresis)>threshold2” are both satisfied, the entering condition may be determined to be satisfied. In addition, if at least one of condition “(serving L2 U2N relay UE's measurement value-hysteresis)>threshold1” or condition “(candidate L2 U2N relay UE's measurement value+hysteresis)<threshold2” is satisfied, the leaving condition may be determined to be satisfied.
Event Z2: The measurement value of the candidate L2 U2N relay UE is higher than the measurement value of the serving L2 U2N relay UE by an offset or more. Specifically, if condition “(candidate L2 U2N relay UE's measurement value-hysteresis)> (serving L2 U2N relay UE's measurement value+offset)” is satisfied, the entering condition may be determined to be satisfied. In addition, if condition “(candidate L2 U2N relay UE's measurement value+hysteresis)< (serving L2 U2N relay UE's measurement value+offset)” is satisfied, the leaving condition may be determined to be satisfied.

Measurement report triggering 1021 of the L2 U2N remote UE 1020 may be performed when reportType is eventTriggered and the layer 3 filtered value satisfies the entering or leaving condition of the above event (i.e., event Z1 or event Z2) for a period of timeToTrigger. Layer 3 filtering parameters for measurement report triggering 1021 may be set as described in Table 4 above.

In the measurement report triggering event Z1, SL-RSRP or SD-RSRP of the serving relay UE 1030 may be compared with threshold1, and SD-RSRP of the candidate relay UE 1010 may be compared with threshold2. To measure SD-RSRP of the candidate relay UE 1010, a sidelink signal 1011 may be received from the candidate relay UE 1010. Here, if the measurement quantity of the serving relay UE 1030 being measured by the L2 U2N remote UE 1020 is limited to SL-RSRP or SD-RSRP, or if the respective thresholds are not set, the L2 U2N remote UE 1020 may be unable to use the measurement quantity intended by the gNB 1040 as illustrated in FIG. 7 or FIG. 9. Further, in the measurement report triggering event Z2, the influence of parameters for Tx power adjustment illustrated in FIG. 7 should be avoided in order to directly compare SL-RSRP or SD-RSRP of the serving relay UE 1030 with SL-RSRP or SD-RSRP of the candidate relay UE 1010.

As an embodiment, in determination of measurement report triggering as to the serving relay UE 1030 based on triggering event Z1, this problem may be solved by using at least one of the following four options.

Option 1: only SL-RSRP may be used as the measurement quantity for the serving relay UE 1030. When evaluating the entering and leaving conditions in measurement report triggering event Z1, it may be explicitly specified that only SL-RSRP be used. That is, it may be expressed as “Mr is the SL-RSRP of the serving L2 U2N relay UE.”, and Mr may be expressed as “Mr is the measurement result of the serving L2 U2N relay UE, not taking into account any offsets.” In addition, the measurement result included in the measurement report 1022 may only include SL-RSRP. In other words, “NOTE 1: In case of no data transmission from L2 U2N relay UE to L2 U2N remote UE, it is left to UE implementation whether to use SL-RSRP or SD-RSRP when setting the sl-MeasResultServingRelay of the serving L2 U2N relay UE.” may be not used.
Option 2: only SD-RSRP may be used as the measurement quantity for the serving relay UE 1030. When evaluating the entering and leaving conditions in measurement report triggering event Z1, it may be explicitly specified that only SD-RSRP be used. That is, it may be expressed as “Mr is the SD-RSRP of the serving L2 U2N relay UE.”, and Mr may be expressed as “Mr is the measurement result of the serving L2 U2N relay UE, not taking into account any offsets.” In addition, the measurement result included in the measurement report 1022 may only include SD-RSRP. That is, this may be expressed as follows: “3> set the sl-MeasResult to include the SD-RSRP of the serving L2 U2N relay UE;”
Option 3: by adding a lower-level indicator to MeasTriggerQuantity, only one of SL-RSRP and SD-RSRP may be used as the measurement quantity in one measurement report triggering event. For example, by setting sl-SL-RSRP and sl-SD-RSRP indicators as shown in Table 10, sl-SL-RSRP may be used in the entering or leaving condition in case of measurement with SL-RSRP, and sl-SD-RSRP may be used in the entering or leaving condition in case of measurement with SD-RSRP. The existing sl-RSRP may be used in the same way without adding sl-SL-RSRP.

TABLE 10

| | |
|---|---|
| SL-MeasTriggerQuantity-r16 ::= | CHOICE { |
| sl-RSRP-r16 | RSRP-Range, |
| sl-SL-RSRP-r17xy | RSRP-Range, |
| sl-SD-RSRP-r17xy | RSRP-Range, |

...
}

Option 4: by specifying one or more measurement quantities in MeasTriggerQuantity, SL-RSRP and/or SD-RSRP may be used as a measurement quantity in one measurement report triggering event. For example, by setting sl-SL-RSRP and sl-SD-RSRP indicators for one MeasTriggerQuantity as shown in Table 11, sl-SL-RSRP may be used in the entering or leaving condition in case of measurement with SL-RSRP, and sl-SD-RSRP may be used in the entering or leaving condition in case of measurement with SD-RSRP. The existing sl-RSRP may be used in the same way without adding sl-SL-RSRP.

TABLE 11

| | |
|---|---|
| SL-MeasTriggerQuantity-r18 ::= | SEQUENCE { |
| sl-RSRP-r16 | RSRP-Range, |
| sl-SL-RSRP-r18 | RSRP-Range, |
| sl-SD-RSRP-r18 | RSRP-Range, |

...
}

New measurement report triggering event Z1 may have a form as shown in Table 12, for example.

TABLE 12

| | |
|---|---|
| eventZ1-r18 | SEQUENCE { |
| (1) z1-Threshold1-Relay-r18 | SL-MeasTriggerQuantity-r18, |
| (2) z1-Threshold1-Relay-r18 | SL-MeasTriggerQuantity-r16, |
| (2) z1-Threshold1-1-Relay-r18 | SL-MeasTriggerQuantity-r16, |
| z1-Threshold2-r18 | SL-MeasTriggerQuantity-r16, |
| reportOnLeave-r17 | BOOLEAN, |
| hysteresis-r17 | Hysteresis, |
| timeToTrigger-r17 | TimeToTrigger, |
| useAllowedCellList-r17 | BOOLEAN |

},

In each event, the threshold may be set in the form of (1) or (2). SL-MeasTriggerQuantity-r18 set in the form of (1) may simultaneously set thresholds for SL-RSRP and SD-RSRP with one SL-MeasTriggerQuantity. Since SL-MeasTriggerQuantity-r16 set in the form of (2) may only include one threshold (i.e., sl-RSRP), an additional threshold for SD-RSRP may be set via z1-Threshold1-1-Relay. In case of measurement with SL-RSRP, it is possible to utilize sl-RSRP, sl-SL-RSRP, or z1-Threshold1-Relay in the entering or leaving condition; in case of measurement with SD-RSRP, it is possible to utilize sl-SD-RSRP or z1-Threshold1-1-Relay in the entering or leaving condition.

As an embodiment, in determination of measurement report triggering as to triggering event Z2, the problem of directly comparing SL-RSRP and SD-RSRP may be solved by using at least one of the following four options:
Option 1: only SD-RSRP may be used as the measurement quantity for the serving relay UE 1030. When evaluating the entering and leaving conditions in measurement report triggering event Z2, it may be specified that only SD-RSRP be used. That is, this may be expressed as “Mr is the SD-RSRP of the serving L2 U2N relay UE.”, and Mr may be expressed as “Mr is the measurement result of the serving L2 U2N relay UE, not taking into account any offsets.” In addition, this may be expressed as “Mn is the SD-RSRP of the candidate L2 U2N relay UE.”, and Mn may be expressed as “Mn is the measurement result of the candidate L2 U2N relay UE, not taking into account any offsets.” The measurement result of the serving relay UE 1030 included in the measurement report 1022 may include only SD-RSRP. That is, it may be expressed as follows: “3> set the sl-MeasResult to include the SD-RSRP of the serving L2 U2N relay UE;” Here, the offset setting (e.g., SL-MeasTriggerQuantityOffset) may be given as one offset as in Table 13, for example.

TABLE 13

| | |
|---|---|
| SL-MeasTriggerQuantityOffset-r18 ::= | CHOICE { |
| sl-rsrp-r18 | INTEGER (−30..30), |

...
}

Option 2: only the same measurement quantity (i.e., SL-RSRP or SD-RSRP) may be used as the measurement quantity for the serving relay UE 1030 and candidate relay UE 1010. When evaluating the entering condition and the leaving condition in measurement report triggering event Z2, it may be explicitly specified to use the same measurement quantity. That is, this may be expressed as “Mr and Mn are the same measurement quantity.” Mr can be expressed as “Mr is the measurement result of the serving L2 U2N relay UE, not taking into account any offsets.” Mn can be expressed as “Mn is the measurement result of the candidate L2 U2N relay UE, not taking into account any offsets.” Here, the offset setting (e.g., SL-MeasTriggerQuantityOffset) may be given as one offset as in Table 14, for example.

TABLE 14

| | |
|---|---|
| SL-MeasTriggerQuantityOffset-r18 ::= | CHOICE { |
| sl-rsrp-r18 | INTEGER (−30..30), |

...
}

Option 3: only one of SL-RSRP and SD-RSRP may be explicitly used as the measurement quantity in the setting of MeasTriggerQuantityOffset. For example, by setting sl-SL-RSRP and sl-SD-RSRP indicators as in Table 15, when the measurement quantity for the serving relay UE 1030 and candidate relay UE 1010 is SL-RSRP, sl-SL-RSRP may be used in the entering or leaving condition; when the measurement quantity for the serving relay UE 1030 and candidate relay UE 1010 is SD-RSRP, sl-SD-RSRP may be used in the entering or leaving condition.

TABLE 15

| | |
|---|---|
| SL-MeasTriggerQuantityOffset-r18 ::= | CHOICE { |
| sl-SL-rsrp-r18 | INTEGER (−30..30), |
| sl-SD-rsrp-r18 | INTEGER (−30..30), |

...
}

Option 4: by specifying one or more measurement quantities in the MeasTriggerQuantity Offset setting, SL-RSRP and/or SD-RSRP may be used as a measurement quantity in one measurement report triggering event. For example, by setting sl-SL-RSRP and sl-SD-RSRP indicators in one MeasTriggerQuantityOffset as in Table 16, sl-SL-RSRP may be used in the entering or leaving condition in case of measurement with SL-RSRP, and sl-SD-RSRP may be used in the entering or leaving condition in case of measurement with SD-RSRP.

TABLE 16

| | |
|---|---|
| SL-MeasTriggerQuantityOffset-r18 ::= | SEQUENCE { |
| sl-SL-rsrp-r18 | INTEGER (−30..30), |
| sl-SD-rsrp-r18 | INTEGER (−30..30), |

...
}

New measurement report triggering event Z2 may have the form as shown in Table 17, for example.

TABLE 17

| eventZ2-r18 | SEQUENCE { |
|---|---|
| z2-Offset-r18 | SL-MeasTriggerQuantityOffset- |
| r18, | |
| reportOnLeave-r17 | BOOLEAN, |
| hysteresis-r17 | Hysteresis, |
| timeToTrigger-r17 | TimeToTrigger, |
| useAllowedCellList-r17 | BOOLEAN |

},

In event Z2, the offset set as SL-MeasTriggerQuantityOffset-r18 may simultaneously set the SL-RSRP and SD-RSRP offsets, or SL-MeasTriggerQuantityOffset-r18 set in the form of option 1 or option 2 may include only one threshold (i.e., sl-RSRP).

As an embodiment, the measurement result of the serving relay UE 1030 included in the measurement report 1022 may include the same measurement result as SL-RSRP or SD-RSRP indicated by SL-MeasTriggerQuantity or SL-MeasTriggerQuantityOffset, or reportQuantityServingRelay explicitly indicating the measurement result may be newly defined as shown in Table 18.

TABLE 18

| | |
|---|---|
| reportQuantityServingRelay | SL-MeasReportQuantity-r18 |
| SL-MeasReportQuantity ::= | CHOICE { |
| sl-SL-RSRP-r18 | BOOLEAN, |
| sl-SD-RSRP-r18 | BOOLEAN, |

...
}

The measurement report 1022 transmitted by the L2 U2N remote UE 1020 to the gNB 1040 may include sl-MeasResultServingRelay, and sl-MeasResult being a lower-level IE of sl-MeasResultServingRelay may include a result value measured with the measurement quantity indicated by reportQuantityServingRelay, a result value measured with the same measurement quantity as SL-MeasTriggerQuantity, a result value measured with the same measurement quantity as SL-MeasTriggerQuantityOffset, SL-RSRP, or SD-RSRP. That is, this may be expressed as (1) to (5) in Table 19.

TABLE 19
“ 2> set the sl-MeasResultServingRelay in accordance with the following:
...
3> set the sl-MeasResult to include the quantity(ies) indicated in the (1)
reportQuantityServingRelay (2) SL-MeasTriggerQuantity (3) SL-MeasTriggerQuantityOffset (4)
SL-RSRP (5) SD-RSRP of the serving L2 U2N relay UE;”

In addition, if at least one of the two measurement quantities satisfies the entering or leaving condition, SL-RSRP and SD-RSRP may be included in one sl-MeasResultServingRelay, and SL-RSRP and SD-RSRP may be differentiated by different IEs.

The measurement report 1022 transmitted by the L2 U2N remote UE 1020 to the gNB 1040 may include sl-MeasResultCandRelay, and sl-MeasResult being a lower-level IE of sl-MeasResultCandRelay may include a result value measured with the same measurement quantity as SL-MeasTriggerQuantity, a result value measured with the same measurement quantity as SL-MeasTriggerQuantityOffset, SL-RSRP, or SD-RSRP. That is, this may be expressed as (1) to (4) in Table 20.

TABLE 20
“ 2> set the sl-MeasResultServingRelay in accordance with the following:
...
3> set the sl-MeasResult to include the quantity(ies) indicated in the (1) SL-
MeasTriggerQuantity (2) SL-MeasTriggerQuantityOffset (3) SL-RSRP (4) SD-RSRP of the
serving L2 U2N relay UE;”

In addition, if at least one of the two measurement quantities satisfies the entering or leaving condition, SL-RSRP and SD-RSRP may be included in one MeasResultsCandRelay, and SL-RSRP and SD-RSRP may be differentiated by different IEs.

SL-RSRP or SD-RSRP for one or more candidate relay UEs 1010 included in the measurement report 1022 may be included in sl-MeasResult IE being a lower-level IE of SL-MeasResultRelay, and SL-MeasResultListRelay may include at least one SL-MeasResultRelay. Here, SL-MeasResultRelay instances may be sorted in descending order based on the measurement quantity indicated by reportQuantityRelay and included in SL-MeasResultListRelay. Since reportQuantityRelay as SL-MeasReportQuantity-r16 can only include sl-RSRP, if the measurement report includes both SL-RSRP and SD-RSRP, for sorting in descending order based on SL-RSRP or SD-RSRP, SL-RSRP or SD-RSRP may be explicitly set as a criterion by adding a lower-level indicator to option 3 of event Z1, that is, MeasTriggerQuantity, or sorting may be performed based only on SD-RSRP.

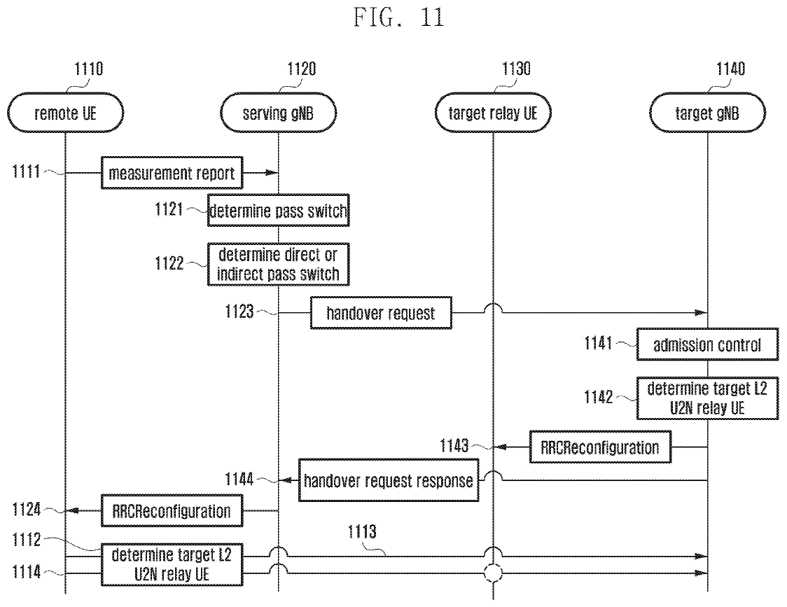

FIG. 11 is a diagram illustrating signal flows in which the base station performs pass switching based on signals of a U2N relay UE and a candidate U2N relay UE reported by a U2N remote UE in a wireless communication system according to an embodiment of the disclosure.

With reference to FIG. 11, at step 1111, the L2 U2N remote UE 1110 may transmit a measurement report for the serving relay UE and/or NR cell to the serving gNB 1120 according to measurement report triggering event X1, event X2, event X1-1, or event X2-1 as illustrated in relation to FIG. 9. In addition, the L2 U2N remote UE 1110 may transmit a measurement report for the serving relay UE and at least one candidate relay UE to the serving gNB 1120 according to measurement report triggering event Z1 or event Z2 as illustrated in relation to FIG. 10.

The serving gNB 1120 may determine pass switching of the L2 U2N remote UE 1110 based on the measurement report 1111 received from the L2 U2N remote UE 1110 (1121), where it may determine indirect-to-direct path switch, which switches the L2 U2N remote UE 1110 served by an indirect path through the serving relay UE onto a direct path of the same or different gNB 1120 or 1140, or indirect-to-indirect path switch, which switches the L2 U2N remote UE 1110 served by an indirect path through the serving relay UE to an indirect path of another serving relay (1122). The serving gNB 1020 may determine measurement results for other base stations and information on other base stations in a case of performing indirect-to-direct pass switching of the L2 U2N remote UE 1110, or a target gNB 1140 serving the candidate relay UE in a case of performing indirect-to-indirect pass switching. Here, the target gNB 1140 may be the same as or different from the serving gNB, and there may be more than one target gNB 1140.

For indirect-to-direct or indirect-to-indirect path switching, the serving gNB 1120 may transmit a handover request to the target gNB 1140 via XnAP or NGAP (1123). In case of indirect-to-direct pass switching, the handover request 1123 may include information about the L2 U2N remote UE 1110. In case of indirect-to-indirect pass switching, the handover request 1123 may include information about the L2 U2N remote UE 1110 and at least one candidate relay UE.

The target gNB 1140 may determine whether to allow direct or indirect pass switching of the L2 U2N remote UE 1110 by applying admission control based on the information included in the handover request 1123 (1141).

In case of indirect-to-indirect pass switching, the target gNB 1140 may determine a suitable target L2 U2N relay UE 1130 among the candidate relay UEs included in the handover request 1123 (1142). The target gNB 1140 may select a target relay UE 1130 other than the candidate relay UE included in the handover request 1123.

The target gNB 1140 may transmit information for the relaying service of the L2 U2N remote UE 1110 to the target relay UE 1130 via an RRCReconfiguration message (1143). The information transmitted at this time may be the same as remote UE addition (823) illustrated in FIG. 8.

The target gNB 1140 may transmit a handover request response (acknowledge) to the serving gNB 1120 via XnAP or NGAP (1144). The handover request response 1144 may include a configuration that the L2 U2N remote UE 1110 should use at the target gNB 1140 or the target relay UE 1130, and may also include information about the target relay UE 1130.

The serving gNB 1120 may transmit an RRCReconfiguration message with Reconfiguration WithSync to indicate direct or indirect path switching to the L2 U2N remote UE 1110 (1124). If direct path switching is indicated, the L2 U2N remote UE 1110 may complete path switching by transmitting an RRCReconfigurationComplete message to the target gNB 1140 indicated by the serving gNB 1120 through a direct path 1113 (1112); If indirect pass switching is indicated, the L2 U2N remote UE 1110 may complete pass switching by transmitting an RRCReconfigurationComplete message to the target gNB 1140 through an indirect link 1114 via the target relay UE 1130 indicated by the serving gNB 1120 (1112). Although not shown in the drawing, the establishment of a PC5 unicast link between the L2 U2N remote UE 1110 and the target relay UE 1130 may precede message transmission through an indirect link, and the establishment of the unicast link may be performed after step 1143, or before or after step 1124.

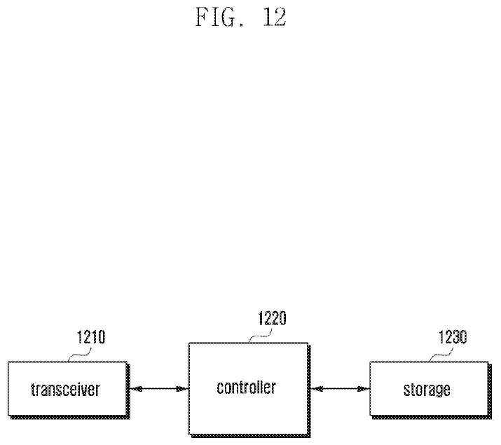

FIG. 12 is a diagram illustrating the structure of a base station in a wireless communication system according to an embodiment of the disclosure.

With reference to FIG. 12, the base station may include a transceiver 1210, a controller 1220, and a storage 1230. The transceiver 1210, controller 1220, and storage 1230 may operate according to the communication method of the base station described above. Network devices may also correspond in structure to the base station. However, the components of the base station are not limited to those described above. For example, the base station may include more or fewer components than those described above. For example, a base station may include a transceiver 1210 and a controller 1220. Further, the transceiver 1210, controller 1220, and storage 1230 may be implemented in the form of a single chip.

The transceiver 1210 collectively refers to the receiver and transmitter of the base station, and may transmit and receive signals to and from UEs, other base stations, or other network devices. Here, the signal transmitted and received may include control information and data. The transceiver 1210 may transmit, for example, system information to a UE, and may transmit synchronization signals or reference signals. To this end, the transceiver 1210 may be composed of an RF transmitter that up-converts and amplifies the frequency of a signal to be transmitted, and an RF receiver that low-noise amplifies and down-converts the frequency of a received signal. However, this is only one embodiment of the transceiver 1210, and the components of the transceiver 1210 are not limited to the RF transmitter and RF receiver. The transceiver 1210 may include a wired or wireless transceiver and may include various components for transmitting and receiving signals. Additionally, the transceiver 1210 may receive a signal via a communication channel (e.g., radio channel) and output it to the controller 1220, and may transmit a signal output from the controller 1220 via a communication channel. In addition, the transceiver 1210 may receive a communication signal and output it to the processor, and may transmit a signal output from the processor to a UE, another base station, or another entity through a wired or wireless network.

The storage 1230 may store programs and data necessary for the operation of the base station. Additionally, the storage 1230 may store control information or data included in signals obtained by the base station. The storage 1230 may be composed of a storage medium, such as ROM, RAM, hard disk, CD-ROM, or DVD, or a combination of storage media. In addition, the storage 1230 may store at least one of information transmitted and received through the transceiver 1210 or information generated through the controller 1220.

In this disclosure, the controller 1220 may be referred to as a circuit, an application-specific integrated circuit, or at least one processor. The processor may include a communication processor (CP) that controls communication, and an application processor (AP) that controls higher layers such as application programs. The controller 1220 may control the overall operation of the base station according to the embodiments proposed in the disclosure. For example, the controller 1220 may control the signal flow between blocks to execute operations according to the flowchart described above. The controller 1220 may include at least one processor. For example, overall operations of the base station according to an embodiment of the disclosure may be controlled by at least one processor. For instance, at least one processor may divide and control overall operations of the base station according to an embodiment of the disclosure.

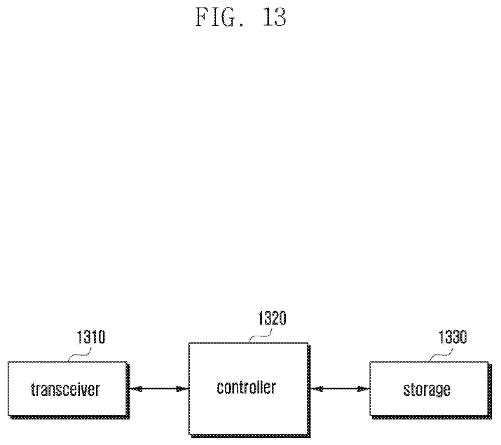

FIG. 13 is a diagram illustrating the structure of a UE in a wireless communication system according to various embodiments of the disclosure.

With reference to FIG. 13, the UE may include a transceiver 1310, a controller 1320, and a storage 1330. The transceiver 1310, controller 1320, and storage 1330 may operate according to the communication method of the UE described above. However, the components of the UE are not limited to those described above. For example, the UE may include more or fewer components than those described above. For example, a UE may include a transceiver 1310 and a controller 1320. Further, the transceiver 1310, controller 1320, and storage 1330 may be implemented in the form of a single chip.

The transceiver 1310 collectively refers to the receiver and transmitter of the UE, and may transmit and receive signals to and from a base station, other UEs, or network entities. The signal transmitted and received to and from a base station may include control information and data. The transceiver 1310 may receive, for example, system information from a base station, and may receive synchronization signals or reference signals. To this end, the transceiver 1310 may be composed of an RF transmitter that up-converts and amplifies the frequency of a signal to be transmitted, and an RF receiver that low-noise amplifies and down-converts the frequency of a received signal. However, this is only one embodiment of the transceiver 1310, and the components of the transceiver 1310 are not limited to the RF transmitter and RF receiver. Additionally, the transceiver 1310 may include a wired or wireless transceiver and may include various components for transmitting and receiving signals. Additionally, the transceiver 1310 may receive a signal via a radio channel and output it to the controller 1320, and may transmit a signal output from the controller 1320 via a radio channel. In addition, the transceiver 1310 may receive a communication signal and output it to the processor, and may transmit a signal output from the processor to a network entity through a wired or wireless network.

The storage 1330 may store programs and data necessary for the operation of the UE. Additionally, the storage 1330 may store control information or data included in signals obtained by the UE. The storage 1330 may be composed of a storage medium, such as ROM, RAM, hard disk, CD-ROM, or DVD, or a combination of storage media.

In this disclosure, the controller 1320 may be referred to as a circuit, an application-specific integrated circuit, or at least one processor. The processor may include a communication processor (CP) that controls communication, and an application processor (AP) that controls higher layers such as application programs. The controller 1320 may control the overall operation of the UE according to the embodiments proposed in the disclosure. For example, the controller 1320 may control the signal flow between blocks to execute operations according to the flowchart described above. The controller 1320 may include at least one processor. For example, overall operations of the UE according to an embodiment of the disclosure may be controlled by at least one processor. For instance, at least one processor may divide and control overall operations of the UE according to an embodiment of the disclosure.

When a remote UE is connected to a gNB through a sidelink connection with a layer-2 relay UE, or when a remote UE is connected to a gNB through a sidelink connection with a layer-3 relay UE, or when a remote UE is connected to another remote UE through a sidelink connection, a procedure for searching for a layer-2 relay UE, a procedure for searching for a layer-3 relay UE, or a procedure for searching for another remote UE may be performed, respectively.

In the procedure for discovering a layer-2 relay UE, the layer-2 relay UE or remote UE may transmit or receive a relay discovery message. In the procedure for discovering a layer-3 relay UE, the layer-3 relay UE or remote UE may transmit or receive a relay discovery message. In the procedure for discovering another remote UE, the remote UE or another remote UE may transmit or receive a discovery message to find the counterpart UE.

When a layer-2 relay UE, a layer-2 remote UE, a layer-3 relay UE, a layer-3 remote UE, or a remote UE is located within the coverage of a gNB, the layer-2 relay UE, the layer-2 remote UE, the layer-3 relay UE, the layer-3 remote UE, or the remote UE (meaning a UE that performs a procedure for finding a counterpart UE other than relay operation) may transmit or monitor a relay discovery message for layer-3 relay operation, a relay discovery message for layer-2 relay operation, or a discovery message for finding a counterpart UE by using sidelink resources configured and provided by the gNB.

For a layer-2 relay UE or layer-2 remote UE to perform relay discovery message transmission or monitoring for layer-2 relay operation by using sidelink resources configured and provided by a gNB, the relay UE or remote UE should determine whether the gNB supports layer-2 relay operation, and if so, the relay UE or remote UE may perform relay discovery message transmission or monitoring for layer-2 relay operation by using sidelink resources configured and provided by the gNB. For a layer-3 relay UE or layer-3 remote UE to perform relay discovery message transmission or monitoring for layer-3 relay operation by using sidelink resources configured and provided by a gNB, the relay UE or remote UE should determine whether the gNB supports layer-3 relay operation, and if so, the relay UE or remote UE may perform relay discovery message transmission or monitoring for layer-3 relay operation by using sidelink resources configured and provided by the gNB. For a remote UE to perform discovery message transmission or monitoring for finding a counterpart UE by using sidelink resources configured and provided by a gNB, the remote UE should determine whether the gNB supports discovery operation for finding a counterpart UE other than relay operation, and if so, the remote UE may perform discovery message transmission or monitoring for finding a counterpart UE by using sidelink resources configured and provided by the gNB.

Indication information indicating whether a gNB supports layer-2 relay operation may be provided to the UE via a system information block (SIB) transmitted by the gNB. For example, if the gNB supports layer-2 relay operation, the sl-L2U2N-Relay IE (this field indicates the support of NR sidelink layer-2 relay) in SIB12 may be set to “enabled”. Indication information indicating whether a gNB supports layer-3 relay operation may be provided to the UE via a SIB transmitted by the gNB. For example, if the gNB supports layer-3 relay operation, the sl-L3U2N-RelayDiscovery IE (this field indicates the support of L3 U2N relay AS-layer capability, i.e., NR sidelink relay discovery) in SIB12 may be set to “enabled”. Indication information indicating whether a gNB supports discovery operation for finding a counterpart UE may be provided to the UE via a SIB transmitted by the gNB. For example, if the gNB supports discovery operation for finding a counterpart UE, the sl-NonRelayDiscovery IE (this field indicates the support of NR sidelink non-relay discovery) in SIB12 may be set to “enabled”. An example of SIB12, which includes indication information indicating that the gNB supports layer-2 relay operation, indication information indicating that the gNB supports layer-3 relay operation, or indication information indicating that the gNB supports discovery operation for finding a counterpart UE, is shown in Table 21.

TABLE 21

| SIB12-IEs-r16 ::= | SEQUENCE { | |
|---|---|---|
| sl-ConfigCommonNR-r16 | SL-ConfigCommonNR-r16, | |
| lateNonCriticalExtension | OCTET STRING | OPTIONAL, |

```
  ...,
  [[
  sl-DRX-ConfigCommonGC-BC-r17 SL-DRX-ConfigGC-BC-r17
```

| | |
|---|---|
| OPTIONAL, | -- Need R |

sl-DiscConfigCommon-r17 SL-DiscConfigCommon-r17

| | |
|---|---|
| OPTIONAL, | -- Need R |

| | |
|---|---|
| sl-L2U2N-Relay-r17 ENUMERATED {enabled} | OPTIONAL, -- |

Need R
sl-NonRelay Discovery-r17 ENUMERATED {enabled}

| | |
|---|---|
| OPTIONAL, | -- Need R |

sl-L3U2N-Relay Discovery-r17 ENUMERATED {enabled}

| | |
|---|---|
| OPTIONAL, | -- Need R |

sl-TimersAndConstantsRemoteUE-r17 UE-TimersAndConstantsRemoteUE-r17

| | |
|---|---|
| OPTIONAL | -- Need R |

]]
}

However, according to related-art UE operation, if a relay UE or remote UE needs to monitor a layer-2 relay discovery message for layer-2 relay operation, the relay UE or remote UE uses the layer-2 relay discovery message monitoring resource configured by the SIB without checking whether the gNB supports layer-2 relay operation. Or, if a relay UE or remote UE needs to monitor a layer-3 relay discovery message for layer-3 relay operation, the relay UE or remote UE utilizes the layer-3 relay discovery message monitoring resource configured by the SIB without checking whether the base station supports layer-3 relay operation. Or, if a remote UE needs to monitor a discovery message for discovery operation to find a counterpart UE, the remote UE uses the remote UE discovery message monitoring resource configured by the SIB without checking whether the base station supports discovery operation for finding a counterpart UE.

Embodiments of related-art UE operation for layer-2 relay discovery message monitoring, related-art UE operation for layer-3 relay discovery message monitoring, or related-art UE operation for remote UE discovery message monitoring to find a counterpart UE, and embodiments of related-art UE operation for processing an SIB message including a discovery message monitoring resource configured by a gNB for layer-2 relay discovery message monitoring, related-art UE operation for processing an SIB message including a discovery message monitoring resource configured by a gNB for layer-3 relay discovery message monitoring, or related-art UE operation for processing an SIB message including a discovery message monitoring resource configured by a gNB for remote UE discovery message monitoring to find a counterpart UE are as shown in Table 22.

TABLE 22
NR sidelink discovery monitoring
A UE capable of NR sidelink discovery that is configured by upper layers to monitor NR
sidelink discovery messages shall:

| 1> | if the frequency used for NR sidelink discovery is included in sl-FreqInfoList included | |
|---|---|---|
| | in SIB12 and sl-DiscConfigCommon is included in SIB12: | |
| | 2> | if the cell chosen for NR sidelink discovery reception provides SIB12: |
| | | 3> if sl-DiscRxPool for NR sidelink is included in SIB12: |

| | |
|---|---|
| 4> | configure lower layers to monitor sidelink control information and the |
| | corresponding data using the resource pool indicated by sl-DiscRxPool for |
| | NR sidelink discovery reception in SIB12; |

| | |
|---|---|
| 3> | else if sl-RxPool for NR sidelink is included in SIB12: |

| | |
|---|---|
| 4> | configure lower layers to monitor sidelink control information and the |
| | corresponding data using the resource pool indicated by sl-RxPool for NR |
| | sidelink discovery reception in SIB12; |

| NOTE: | If sl-DiscRxPool and sl-RxPool are both include in SIB12, it is up to UE |
|---|---|
| | implementation whether to monitor sidelink control information and the |
| | corresponding data using the resource pool indicated by sl-RxPool for NR |
| | sidelink discovery reception. |

UE Actions upon reception of SIB12
Upon receiving SIB12, the UE shall;

| 1> | if the UE has stored at least one segment of SIB12 and the value tag of SIB12 has | |
|---|---|---|
| | changed since a previous segment was stored: | |
| | 2> | discard all stored segments; |
| 1> | store the segment; | |
| 1> | if all segments have been received: | |
| | 2> | assemble SIB12-IEs from the received segments; |
| | 2> | if sl-FreqInfoList is included in sl-ConfigCommonNR: |

| | |
|---|---|
| 3> | if configured to receive NR sidelink discovery: |

| | |
|---|---|
| 4> | use the resource pool(s) indicated by sl-DiscRxPool or sl-RxPool for NR |
| | sidelink discovery reception; |

The UE should discard any stored segments for SIB12 if the complete SIB12 has not been
assembled within a period of 3 hours. The UE shall discard any stored segments for SIB12
upon cell (re-)selection.

As described in the above embodiment, in the related art, a UE configured to monitor (receive) a sidelink discovery message and capable of monitoring (receiving) a sidelink discovery message is described to perform operations utilizing sidelink discovery message monitoring (reception) resources indicated by the SIB information transmitted by the gNB. However, if the gNB does not support layer-2 U2N relay discovery, the UE cannot utilize the sidelink discovery message monitoring (reception) resources indicated by the SIB information transmitted by the gNB; if the gNB does not support layer-3 U2N relay discovery, the UE cannot utilize the sidelink discovery message monitoring (reception) resources indicated by the SIB information transmitted by the gNB; or, if the gNB does not support discovery operation for finding a counterpart UE, the UE cannot utilize the sidelink discovery message monitoring (reception) resources indicated by the SIB information transmitted by the gNB. Because of this, the UE may incorrectly perform sidelink discovery message monitoring (reception). In the related art, there is no synchronization in utilization of sidelink discovery message monitoring (reception) resources between the UE and the gNB.

In addition, if considering a case where the gNB supports layer-2 U2N relay operation, layer-3 U2N relay operation, or discovery of a counterpart UE as to UE's utilization of sidelink discovery message transmission resources, but if not considering a case where the gNB supports layer-2 U2N relay operation, layer-3 U2N relay operation, or discovery of a counterpart UE as to UE's utilization of sidelink discovery message monitoring resources, the UE configured to monitor (receive) a sidelink discovery message may unnecessarily monitor the sidelink discovery message reception resources, resulting in a battery consumption problem. For example, if a specific cell does not support layer-2 U2N relay operation and thus sidelink resources provided by this cell are not used for layer-2 U2N relay discovery message transmission, a UE within the coverage of this cell do not need to monitor the sidelink resources provided by this cell for a layer-2 U2N relay discovery message. However, a UE configured to monitor sidelink resources to receive a layer-2 U2N relay discovery message may consume battery for receiving a layer-2 U2N relay discovery message that will not be transmitted because the UE monitors sidelink resources without checking whether layer-2 U2N relay operation is supported.

Accordingly, an embodiment of the disclosure proposes a method that, when a UE needs to use a sidelink discovery message monitoring (reception) resource, determines whether the gNB supports sidelink discovery message monitoring (reception), determines whether the gNB configures/provides a resource for sidelink discovery message monitoring (reception), and utilizes a resource for sidelink discovery message monitoring (reception) configured/provided by the gNB, particularly set/provided in SIB information transmitted by the gNB.

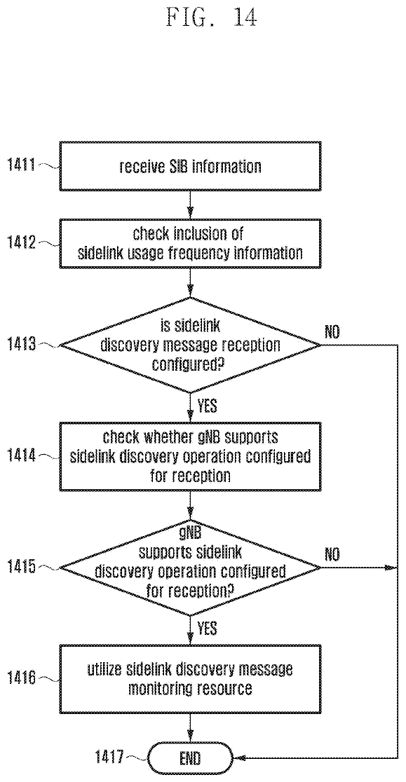

FIG. 14 is a diagram illustrating UE operation for handling sidelink discovery message monitoring according to an embodiment of the present disclosure.

With reference to FIG. 14, the following description focuses on the operation of the UE (layer-2 relay UE or layer-2 remote UE) performing relay discovery message monitoring for layer-2 relay operation by checking the gNB's layer-2 relay operation support indicator. However, without being limited thereto, the embodiment of FIG. 14 may be applied to the operation of the UE (layer-3 relay UE or layer-3 remote UE) performing relay discovery message monitoring for layer-3 relay operation by checking the gNB's layer-3 relay operation support indicator. Additionally, the embodiment of FIG. 14 may be applied to the operation of the UE (remote UE) performing discovery message monitoring to find a counterpart UE by checking the gNB's counterpart UE discovery operation support indicator.

With reference to FIG. 14, at step 1411, a UE having a capability of performing sidelink discovery and being authorized to perform sidelink discovery may obtain (receive) SIB information transmitted by the gNB. Here, the UE may correspond to a layer-2 relay UE or layer-2 remote UE performing layer-2 relay operation, a layer-3 relay UE or layer-3 remote UE performing layer-3 relay operation, or a non-relay discovery remote UE performing counterpart UE discovery operation. The SIB information obtained by the UE at step 1411 may include configuration/resource information for sidelink discovery operation and may include, for example, SIB12.

At step 1412, the UE may check sidelink usage frequency information included in the SIB information. The sidelink usage frequency information included in the SIB information of step 1412 may include at least one or a combination of a frequency used for layer-2 relay operation, a frequency used for layer-3 relay operation, or a frequency used for counterpart UE discovery operation.

At step 1413, the UE may determine whether it is configured to receive a sidelink discovery message according to an indication from its higher layer. The sidelink discovery message reception configuration set in the UE at step 1413 may include at least one or a combination of a layer-2 relay discovery message reception setting for layer-2 relay operation, a layer-3 relay discovery message reception setting for layer-3 relay operation, or a discovery message reception setting for counterpart UE discovery operation.

Upon determining at step 1413 that it is configured to receive a sidelink discovery message according to an indication from its higher layer, in step 1414, the UE may check whether the SIB information received at step 1411 includes an indicator indicating whether the gNB supports the sidelink discovery operation for which the UE is configured. If the UE is configured to receive a layer-2 relay discovery message for layer-2 relay operation based on the determination at step 1413, the UE may check at step 1414 whether the SIB information includes an indicator indicating that the gNB supports layer-2 relay discovery. If the UE is configured to receive a layer-3 relay discovery message for layer-3 relay operation based on the determination at step 1413, the UE may check at step 1414 whether the SIB information includes an indicator indicating that the gNB supports layer-3 relay discovery. If the UE is configured to receive a discovery message for counterpart UE discovery based on the determination at step 1413, the UE may check at step 1414 whether the SIB information includes an indicator indicating that the gNB supports counterpart UE discovery.

If sidelink discovery message reception is not configured according to the determination at step 1413, the UE may proceed to step 1417 and terminate the sidelink discovery message reception processing procedure.

Upon determining at step 1415 that the gNB supports the sidelink discovery operation configured to the UE according to determination at step 1414, at step 1416, the UE may monitor (receive) a sidelink discovery message by using the sidelink discovery message monitoring resource indicated by the SIB information at step 1411. Specifically, if the UE is configured to perform layer-2 relay discovery and the gNB supports layer-2 relay operation, at step 1416, the UE may monitor a layer-2 relay discovery message by using a sidelink discovery message monitoring resource. If the UE is configured to perform layer-3 relay discovery and the gNB supports layer-3 relay operation, at step 1416, the UE may monitor a layer-3 relay discovery message by using a sidelink discovery message monitoring resource. If the UE is configured to perform counterpart UE discovery and the gNB supports counterpart UE discovery operation, at step 1416, the UE may monitor a discovery message for finding a counterpart UE by using a sidelink discovery message monitoring resource.

If the SIB information does not include a sidelink discovery operation support indicator (e.g., layer-2 relay operation support indicator, layer-3 relay operation support indicator, or counterpart UE discovery operation support indicator) according to determination at step 1415, the UE may proceed to step 1417 and terminate the sidelink discovery message reception processing procedure.

According to the embodiment of FIG. 14, Table 23 illustrates an embodiment of an operation in which the UE monitors a layer-2 relay discovery message by checking a layer-2 relay operation support indicator of the gNB, an operation in which the UE monitors a layer-3 relay discovery message by checking a layer-3 relay operation support indicator of the gNB, or an operation in which the UE monitors a remote UE discovery message to find a counterpart UE by checking a counterpart UE discovery operation support indicator of the base station.

TABLE 23
5.8.13.2 NR sidelink discovery monitoring
A UE capable of NR sidelink discovery for L2 U2N Relay operation (if UE, e.g., relay UE
or remote UE, is configured to monitor relay discovery message for L2 U2N relay operation),
a UE capable of NR sidelink discovery for L3 U2N Relay operation (if UE, e.g., relay UE
or remote UE, is configured to monitor relay discovery message for L3 U2N relay operation),
or a UE capable of NR sidelink discovery for non-relay discovery operation (if UE, e.g.,
Remote UE, is configured to monitor UE discovery message for finding counterpart remote
UB) that is configured by upper layers to monitor NR sidelink discovery messages shall:

| | |
|---|---|
| 1> | if the frequency used for NR sidelink discovery is included in sl-FreqInfoList included |
| | in SIB12 and sl-DiscConfigCommon and sl-L2U2N-Relay is included in SIB12 (if gNB |
| | supports layer-2 U2N relay discovery and provides layer-2 U2N relay discovery |
| | message monitoring resources via SIB information); or |
| 1> | if the frequency used for NR sidelink discovery is included in sl-FreqInfoList included |
| | in SIB12 and sl-DiscConfigCommon and sl-L3U2N-RelayDiscovery is included in |
| | SIB 12 (if gNB supports layer-3 U2N relay discovery and provides layer-3 U2N relay |
| | discovery message monitoring resources via SIB information); or |
| 1> | if the frequency used for NR sidelink discovery is included in sl-FreqInfoList included |
| | in SIB12 and sl-DiscConfigCommon and sl-NonRelayDiscovery is included in SIB12 |
| | (if gNB supports UE discovery for finding counterpart UE and provides UE discovery |
| | message monitoring resources for finding counterpart UE via SIB information): |

| | |
|---|---|
| 2> | if the cell chosen for NR sidelink discovery reception provides SIB12: |
| 3> | if sl-DiscRxPool for NR sidelink is included in SIB12: |

| | |
|---|---|
| 4> | configure lower layers to monitor sidelink control information and the |
| | corresponding data using the resource pool indicated by sl-DiscRxPool for |
| | NR sidelink discovery reception in SIB12; |

| | |
|---|---|
| 3> | else if sl-RxPool for NR sidelink is included in SIB12: |

| | |
|---|---|
| 4> | configure lower layers to monitor sidelink control information and the |
| | corresponding data using the resource pool indicated by sl-RxPool for NR |
| | sidelink discovery reception in SIB12; |

| NOTE: | If sl-DiscRxPool and sl-RxPool are both include in SIB12, it is up to UE |
|---|---|
| | implementation whether to monitor sidelink control information and the |
| | corresponding data using the resource pool indicated by sl-RxPool for NR |
| | sidelink discovery reception. |

According to the embodiment of FIG. 14, Table 24 illustrates an embodiment of an operation in which the UE processes a SIB message including a discovery message monitoring resource configured by the gNB for monitoring a layer-2 relay discovery message by checking a layer-2 relay operation support indicator of the gNB, or an operation in which the UE processes a SIB message including a discovery message monitoring resource configured by the gNB for monitoring a layer-3 relay discovery message by checking a layer-3 relay operation support indicator of the gNB, or an operation in which the UE processes a SIB message including a discovery message monitoring resource configured by the gNB for monitoring a remote UE discovery message to find a counterpart UE by checking a counterpart UE discovery operation support indicator of the gNB.

TABLE 24
UE Actions upon reception of SIB12 including the resource pool(s) for monitoring

(receiving) NR sidelink discovery message

Upon receiving SIB12, the UE shall:

| 1> | if the UE has stored at least one segment of SIB12 and the value tag of SIB12 has | |
|---|---|---|
| | changed since a previous segment was stored: | |
| | 2> | discard all stored segments; |
| 1> | store the segment; | |
| 1> | if all segments have been received: | |
| | 2> | assemble SIB12-IEs from the received segments; |
| | 2> | if sl-FreqInfoList is included in sl-ConfigCommonNR: |
| | 3> | if configured to receive NR sidelink discovery for L2 U2N Relaying operation |
| | | and sl-L2U2N-Relay is included in SIB12-IEs; or |
| | 3> | if configured to receive NR sidelink discovery for L3 U2N Relaying operation |
| | | and sl-L3U2N-RelayDiscovery is included in SIB12-IEs; or |
| | 3> | if configured to receive NR sidelink discovery for non-relay discovery operation |
| | | and sl-NonRelay Discovery is included in SIB12-IEs: |

| | |
|---|---|
| 4> | use the resource pool(s) indicated by sl-DiscRxPool or sl-RxPool for NR |
| | sidelink discovery reception, as specified in 5.8.13.2 NR sidelink discovery |
| | monitoring; |

The UE should discard any stored segments for SIB12 if the complete SIB12 has not been
assembled within a period of 3 hours. The UE shall discard any stored segments for SIB12
upon cell (re-)selection.

As an embodiment, if a UE not in RRC connected state fails to obtain sidelink transmission resources to be used for transmitting a sidelink discovery message through a SIB message from the gNB, the UE may perform an RRC connection establishment procedure with the gNB and obtain sidelink transmission resources to be used for transmitting a sidelink discovery message from the gNB through a dedicated RRC message. Here, the UE should determine whether to perform an RRC connection establishment procedure to request sidelink transmission resources from the base station for transmitting a sidelink discovery message, and the conditions for determining whether the UE should perform an RRC connection establishment procedure with the gNB are as follows. When a UE supporting sidelink discovery needs to transmit a sidelink discovery message, and the gNB supports sidelink discovery but does not provide a transmission resource pool for sidelink discovery message transmission via a SIB message, these conditions allow the UE to perform an RRC connection procedure. That is, when a UE supporting sidelink discovery needs to transmit a sidelink discovery message, if the base station does not support sidelink discovery, these conditions may prevent the UE from unnecessarily performing an RRC connection procedure. These conditions are explained in detail below.
The UE is configured by its higher layer for sidelink discovery message transmission and there is a sidelink discovery message to be transmitted (the UE supports sidelink discovery operation), and
When SIB messages are received from a cell on which the UE camps, the frequency set in the received valid SIB message includes a frequency at which the UE is configured for sidelink discovery message transmission, and the valid SIB message received by the UE includes an indicator indicating that the gNB supports sidelink discovery operation, and the valid SIB message does not include a sidelink discovery message transmission resource pool to be used in the frequency at which the UE is configured for sidelink discovery message transmission (the gNB supports sidelink discovery operation but does not provide a sidelink discovery message transmission resource).

Here, the indicator indicating that the gNB supports sidelink discovery may be set to an indicator indicating that the gNB supports layer-2 U2N relay discovery, an indicator indicating that the gNB supports layer-3 U2N relay discovery, or an indicator indicating that the gNB supports UE discovery for finding a counterpart UE.

Specifically, the UE may be configured to perform sidelink discovery message transmission for layer-2 U2N relay discovery, or to perform sidelink discovery message transmission for layer-3 U2N relay discovery, or to perform sidelink discovery message transmission for counterpart UE discovery. In the case where resources are required for sidelink discovery message transmission for layer-2 U2N relay discovery, layer-3 U2N relay discovery, or counterpart UE discovery, if the gNB supports layer-2 U2N relay discovery but a sidelink discovery message transmission resource pool corresponding to the frequency set in the SIB message is not included in the SIB message, if the gNB supports layer-3 U2N relay discovery but a sidelink discovery message transmission resource pool corresponding to the frequency set in the SIB message is not included in the SIB message, or if the gNB supports counterpart UE discovery but a sidelink discovery message transmission resource pool corresponding to the frequency set in the SIB message is not included in the SIB message, the UE may determine that the above conditions are satisfied and perform an RRC connection procedure with the gNB.

The UE may be configured to perform sidelink discovery message transmission for layer-2 U2N relay discovery, perform sidelink discovery message transmission for layer-3 U2N relay discovery, or perform sidelink discovery message transmission for counterpart UE discovery. In a case where resources are required to transmit a sidelink discovery message for layer-2 U2N relay discovery, layer-3 U2N relay discovery, or counterpart UE discovery, upon determining that the gNB does not support layer-2 U2N relay discovery, the gNB does not support layer-3 U2N relay discovery, or the gNB does not support counterpart UE discovery, the UE may determine that the conditions for performing an RRC connection establishment operation with the gNB to obtain configuration information required for sidelink discovery message transmission are not satisfied, and may not perform an RRC connection procedure with the gNB.

If the above conditions are satisfied, the UE may perform an RRC connection establishment procedure with the gNB. After the RRC connection establishment procedure, the UE may transmit a sidelink UE information (SidelinkUEInformationNR) message to the gNB so as to request sidelink transmission and reception (monitoring) resources enabling sidelink discovery message transmission and reception (monitoring). The UE may receive an RRC reconfiguration (RRCReconfiguration) message including configuration information for sidelink discovery message transmission and reception (monitoring) resources from the gNB.

Among the above conditions, if the frequency set in the SIB message received by the UE from the gNB does not include a frequency at which the UE is configured for sidelink discovery message transmission, or if the SIB message does not include an indicator indicating that the gNB supports sidelink discovery, i.e., if the gNB does not support layer-2 U2N relay discovery, layer-3 U2N relay discovery, or counterpart UE discovery, the UE may determine that the gNB does not support sidelink discovery message transmission or reception (monitoring). Then, if the UE has a sidelink discovery message transmission resource or sidelink discovery message reception (monitoring) resource configured in advance, the UE may process sidelink discovery message transmission and sidelink discovery message reception by using these resources.

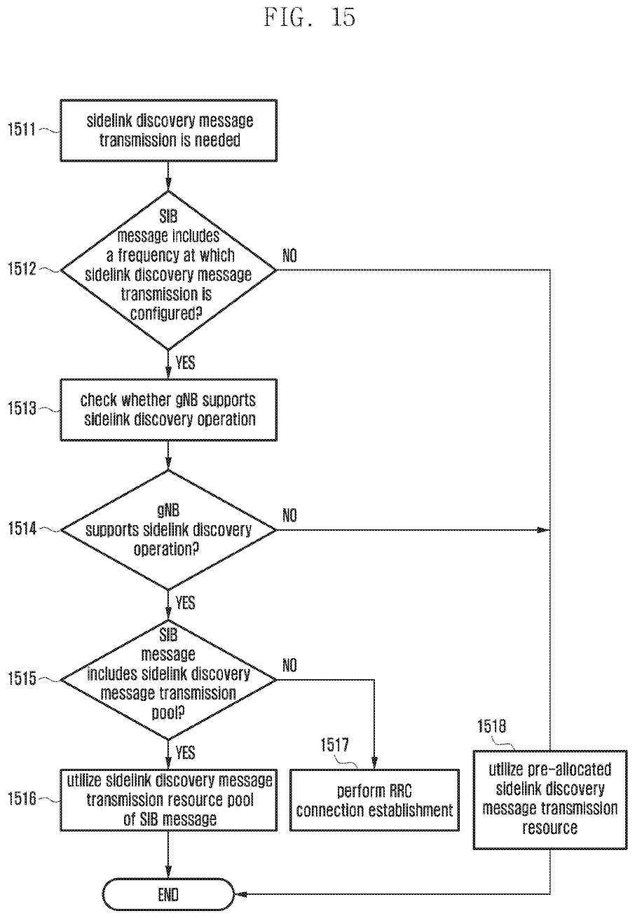

FIG. 15 illustrates UE operation for handling sidelink discovery message transmission according to an embodiment of the disclosure.

With reference to FIG. 15, a description will be given of an operation in which the UE utilizes a sidelink discovery message transmission resource or performs an RRC connection establishment procedure with the gNB based on information included in the SIB message.

With reference to FIG. 15, at step 1511, the UE may obtain configuration information for sidelink discovery messages from higher layer. Based on this configuration information, information regarding sidelink discovery messages to be transmitted may be configured. Based on the configuration information, the UE may determine that there is a sidelink discovery message to be transmitted. For example, the configuration information for sidelink discovery messages may include information indicating at least one or a combination of sidelink discovery message transmission for layer-2 U2N relay discovery by the UE, sidelink discovery message transmission for layer-3 U2N relay discovery, or sidelink discovery message transmission for counterpart UE discovery. The sidelink discovery message to be transmitted by the UE may include at least one or a combination of a sidelink discovery message for layer-2 U2N relay discovery, a sidelink discovery message for layer-3 U2N relay discovery, or a sidelink discovery message for counterpart UE discovery, which is obtained from the higher layer of the UE.

At step 1512, the UE may determine whether the frequency information included in the SIB message transmitted from the camp-on cell includes a frequency corresponding to the UE, i.e., the frequency at which the UE is configured to perform sidelink discovery message transmission for layer-2 U2N relay discovery, layer-3 U2N relay discovery, or counterpart UE discovery.

If the frequency information included in the SIB message includes a frequency at which the UE is configured for sidelink discovery message transmission according to determination at step 1512, in step 1513, the UE may determine whether the gNB supports sidelink discovery operation corresponding to the UE, i.e., layer-2 U2N relay discovery, layer-3 U2N relay discovery, or counterpart UE discovery. The information needed at step 1513 for determining whether the gNB supports sidelink discovery operation (e.g., an indicator indicating whether the gNB supports sidelink discovery) may be included in the SIB message.

Upon determining at step 1512 that the frequency information contained in the SIB message transmitted from the camp-on cell of the UE does not include a frequency at which the UE is configured for corresponding sidelink discovery message transmission, at step 1518, the UE may transmit the sidelink discovery message generated at step 1511 by using sidelink discovery message transmission resources pre-allocated to the UE for sidelink discovery message transmission. The UE operation at step 1518 is not limited thereto.

Upon determining at step 1514 that the gNB supports sidelink discovery operation corresponding to the UE, i.e., layer-2 U2N relay discovery, or layer-3 U2N relay discovery, or counterpart UE discovery based on the information in the SIB message, at step 1515, the UE may determine whether the SIB message includes a transmission resource pool, which enables sidelink discovery message transmission for sidelink discovery operation corresponding to the UE, i.e., layer-2 U2N relay discovery, layer-3 U2N relay discovery, or counterpart UE discovery.

Upon determining at step 1514 that the gNB does not support sidelink discovery operation corresponding to the UE, i.e., layer-2 U2N relay discovery, or layer-3 U2N relay discovery, or counterpart UE discovery, at step 1518, the UE may transmit the sidelink discovery message generated at step 1511 by using sidelink discovery message transmission resources pre-allocated to the UE for sidelink discovery message transmission. The UE operation at step 1518 is not limited thereto.

Upon determining at step 1515 that the SIB message includes a transmission resource pool, which enables sidelink discovery message transmission for sidelink discovery operation corresponding to the UE, i.e., layer-2 U2N relay discovery, layer-3 U2N relay discovery, or counterpart UE discovery, at step 1516, the UE may transmit a sidelink discovery message for sidelink discovery operation corresponding to the UE, i.e., layer-2 U2N relay discovery, layer-3 U2N relay discovery, or counterpart UE discovery by using the sidelink discovery message transmission resource pool included in the SIB message.

Upon determining at step 1515 that the SIB message does not include a transmission resource pool, which enables sidelink discovery message transmission for sidelink discovery operation corresponding to the UE, i.e., layer-2 U2N relay discovery, layer-3 U2N relay discovery, or counterpart UE discovery, at step 1517, the UE may perform an RRC connection establishment procedure with the gNB and transitions to the RRC connected state. For example, the UE having transitioned to the RRC connected state may request the gNB for transmission resources required for sidelink discovery message transmission for the sidelink discovery operation corresponding to the UE, i.e., layer-2 U2N relay discovery, layer-3 U2N relay discovery, or counterpart UE discovery, and may be allocated transmission resources required for sidelink discovery message transmission from the gNB.

The methods according to the embodiments described in the claims or specification of the disclosure may be implemented in the form of hardware, software, or a combination thereof.

When implemented in software, a computer-readable storage medium storing one or more programs (software modules) may be provided. The one or more programs stored in the computer-readable storage medium may be configured to be executable by one or more processors of an electronic device. The one or more programs may include instructions that cause the electronic device to execute the methods according to the embodiments described in the claims or specification of the disclosure.

Such a program (software module, software) may be stored in a random access memory, a nonvolatile memory such as a flash memory, a read only memory (ROM), an electrically erasable programmable read only memory (EEPROM), a magnetic disc storage device, a compact disc ROM (CD-ROM), a digital versatile disc (DVD), other types of optical storage devices, or a magnetic cassette. Or, such a program may be stored in a memory composed of a combination of some or all of them. In addition, a plurality of component memories may be included.

In addition, such a program may be stored in an attachable storage device that can be accessed through a communication network such as the Internet, an intranet, a local area network (LAN), a wide LAN (WLAN), or a storage area network (SAN), or through a communication network composed of a combination thereof. Such a storage device may access the equipment that carries out an embodiment of the disclosure through an external port. In addition, a separate storage device on a communication network may access the equipment that carries out an embodiment of the disclosure.

In the embodiments of the disclosure described above, the elements included in the disclosure are expressed in a singular or plural form according to the presented specific embodiment. However, the singular or plural expression is appropriately selected for ease of description according to the presented situation, and the disclosure is not limited by a single element or plural elements. Those elements described in a plural form may be configured as a single element, and those elements described in a singular form may be configured as plural elements.

Meanwhile, specific embodiments have been described in the detailed description of the disclosure, but various modifications are possible without departing from the scope of the disclosure. Therefore, the scope of the disclosure should not be limited to those embodiments described above, but should be determined according to the patent claims described later and their equivalents.

1. A method performed by a user equipment (UE) in a wireless communication system, the method comprising:
receiving, from a base station, configuration information including information associated with a condition for triggering a measurement report event;
performing a measurement associated with at least one layer 2 (L2) UE-to-network (U2N) relay UE;
determining whether the condition is satisfied based on the configuration information and the measurement; and
transmitting a report on a measurement result to the base station based on satisfaction of the condition,
wherein the information includes at least one of a first threshold associated with a sidelink reference signal received power (SL-RSRP) or a second threshold associated with a sidelink discovery reference signal received power (SD-RSRP), and the first threshold and the second threshold are associated with a measurement for a serving L2 U2N relay UE, and
wherein the information further includes a third threshold associated with a measurement for a candidate L2 U2N relay UE.

2. The method of claim 1, wherein performing the measurement associated with at least one L2 U2N relay UE comprises:
measuring a first SL-RSRP or a first SD-RSRP for the serving L2 U2N relay UE; and
measuring a second SD-RSRP for the candidate L2 U2N relay UE.

3. The method of claim 2, wherein the condition is satisfied in case that the first SL-RSRP is lower than the first threshold and the second SD-RSRP is greater than the third threshold, or in case that the first SD-RSRP is lower than the second threshold and the second SD-RSRP is greater than the third threshold.

4. The method of claim 1, wherein:
in case that a measurement for the serving L2 U2N relay UE is based on an SL-RSRP, the report includes the SL-RSRP of the serving L2 U2N relay UE, and
in case that a measurement for the serving L2 U2N relay UE is based on the SD-RSRP, the report includes the SD-RSRP of the serving L2 U2N relay UE.

5. The method of claim 1, wherein the report further includes information indicating whether the measurement result for the serving L2 U2N relay UE is the SL-RSRP or the SD-RSRP.

6. The method of claim 1, further comprising:
receiving a system information block (SIB);
identifying that an L2 U2N relay discovery message is configured to be transmitted;
identifying that a frequency configured for transmission of the L2 U2N relay discovery message is included in frequency information configured in the SIB and the SIB does not include a transmission resource pool for the frequency; and
initiating radio resource control (RRC) connection establishment.

7. A method performed by a base station in a wireless communication system, the method comprising:
transmitting, to a user equipment (UE), configuration information including information associated with a condition for triggering a measurement report event; and
receiving a report on a measurement result from the UE based on satisfaction of the condition,
wherein whether the condition is satisfied is determined based on the configuration information and a measurement associated with at least one layer 2 (L2) UE-to-network (U2N) relay UE,
wherein the information includes at least one of a first threshold associated with a sidelink reference signal received power (SL-RSRP) or a second threshold associated with a sidelink discovery reference signal received power (SD-RSRP), and the first threshold and the second threshold are associated with a measurement for a serving L2 U2N relay UE, and
wherein the information further includes a third threshold associated with a measurement for a candidate L2 U2N relay UE.

8. The method of claim 7, wherein the measurement associated with the at least one L2 U2N relay UE includes a measurement of a first SL-RSRP or a first SD-RSRP for the serving L2 U2N relay UE, and a measurement of a second SD-RSRP for the candidate L2 U2N relay UE.

9. The method of claim 8, wherein the condition is satisfied in case that the first SL-RSRP is lower than the first threshold and the second SD-RSRP is greater than the third threshold, or in case that the first SD-RSRP is lower than the second threshold and the second SD-RSRP is greater than the third threshold.

10. The method of claim 7, wherein:
in case that a measurement for the serving L2 U2N relay UE is based on an SL-RSRP, the report includes the SL-RSRP of the serving L2 U2N relay UE, and
in case that a measurement for the serving L2 U2N relay UE is based on the SD-RSRP, the report includes the SD-RSRP of the serving L2 U2N relay UE.

11. The method of claim 7, further comprising:
transmitting a system information block (SIB) to the UE; and
initiating radio resource control (RRC) connection establishment with the UE in case that the UE is configured to transmit an L2 U2N relay discovery message, a frequency configured for transmission of the L2 U2N relay discovery message is included in frequency information configured in the SIB, and the SIB does not include a transmission resource pool for the frequency.

12. A user equipment (UE) in a wireless communication system, comprising:
a transceiver; and
at least one processor,
wherein the at least one processor is configured to:
receive, from a base station, configuration information including information associated with a condition for triggering a measurement report event;
perform a measurement associated with at least one layer 2 (L2) UE-to-network (U2N) relay UE;
determine whether the condition is satisfied based on the configuration information and the measurement; and
transmit a report on a measurement result to the base station based on satisfaction of the condition,
wherein the information includes at least one of a first threshold associated with a sidelink reference signal received power (SL-RSRP) or a second threshold associated with a sidelink discovery reference signal received power (SD-RSRP), and the first threshold and the second threshold are associated with measurement for a serving L2 U2N relay UE, and
wherein the information further includes a third threshold associated with a measurement for a candidate L2 U2N relay UE.

13. The UE of claim 12, wherein:
the at least one processor is configured to measure a first SL-RSRP or a first SD-RSRP for the serving L2 U2N relay UE, and measure a second SD-RSRP for the candidate L2 U2N relay UE, and
the condition is satisfied in case that the first SL-RSRP is lower than the first threshold and the second SD-RSRP is greater than the third threshold, or in case that the first SD-RSRP is lower than the second threshold and the second SD-RSRP is greater than the third threshold.

14. The UE of claim 12, wherein:
in case that a measurement for the serving L2 U2N relay UE is based on an SL-RSRP, the report includes the SL-RSRP of the serving L2 U2N relay UE; and
in case that a measurement for the serving L2 U2N relay UE is based on the SD-RSRP, the report includes the SD-RSRP of the serving L2 U2N relay UE.

15. A base station in a wireless communication system, comprising:
a transceiver; and
at least one processor,
wherein the at least one processor is configured to:
transmit, to a user equipment (UE), configuration information including information associated with a condition for triggering a measurement report event; and
receive a report on a measurement result from the UE based on satisfaction of the condition,
wherein whether the condition is satisfied is determined based on the configuration information and a measurement associated with at least one layer 2 (L2) UE-to-network (U2N) relay UE,
wherein the information includes at least one of a first threshold associated with a sidelink reference signal received power (SL-RSRP) or a second threshold associated with a sidelink discovery reference signal received power (SD-RSRP), and the first threshold and the second threshold are associated with measurement for a serving L2 U2N relay UE, and
wherein the information further includes a third threshold associated with a measurement for a candidate L2 U2N relay UE.
